(19) United States
(12) Patent Application Publication
(10) Pub. No.: US 2026/0289551 A1
(43) Pub. Date: Sep. 24, 2026

(54) TRANSFER OF BLOCKCHAIN UNITS TO A BLOCKCHAIN ADDRESS ASSOCIATED WITH AN UNREGISTERED PHONE NUMBER

(71) Applicant: Suku Labs, Inc., Miami, FL (US)

(72) Inventors: Yonathan Lapchik, Miami, FL (US); Lucas Henning, Miami, FL (US); Addison McKenzie, Colorado Springs, CO (US); Rafael Fremd, Montevideo (UY)

(21) Appl. No.: 19/575,468

(22) Filed: Mar. 23, 2026

Related U.S. Application Data
(60) Provisional application No. 63/776,661, filed on Mar. 24, 2025.

(51) Int. Cl. G06Q 20/36; H04L 9/00; H04L 9/08

(52) U.S. Cl. CPC G06Q 20/367; H04L 9/008; H04L 9/0861; H04L 9/50; H04L 2209/46

(57) ABSTRACT

Systems and methods are disclosed for transferring blockchain value to recipients who do not yet control a blockchain address. In response to a request identifying an unregistered phone number and a quantity of blockchain unit, a computing system creates a cryptographic custody associated with a blockchain address that holds the quantity and with a signer of that address. The custody is established by deterministically calculating, from the phone number, the address of an autonomous program protocol and generating corresponding cryptographic signing key material for the signer of the smart account wallet. The system transmits a notification to the phone number containing a URL for access. Upon detecting that a device associated with the phone number has interacted with the URL, the system transmits the signing key material to the device, enabling the device to assume cryptographic control of the autonomous program protocol and access the transferred blockchain unit.

### CROSS REFERENCE TO RELATED APPLICATION(S)

This application claims the benefit of U.S. Provisional Application No. 63/776,661, filed Mar. 24, 2025 and titled “DECENTRALIZED CROSS-BORDER PAYMENT SYSTEM AND METHODS THEREOF,” the content of which is incorporated by reference herein in its entirety.

### BACKGROUND

In conventional approaches, transferring a quantity of blockchain unit may rely on a sender broadcasting a signed transaction that specifies a destination blockchain address, which is known prior to the transfer occurring. The conventional approaches follow protocols that rely on syntactically valid addresses without built-in recipient discovery or confirmation. Addresses are long, opaque identifiers tied to specific blockchains and derivation schemes. Accordingly, transfer systems must obtain and validate the recipient's blockchain address before submission, including the correct network. In conventional approaches, chat messaging platforms lack native blockchain primitives such as embedded wallets, transaction signing, and address resolution. Even minor errors (for example, a character mismatch, chain mismatch, or use of an address that is valid but not controlled for the intended asset) can irreversibly route funds to the wrong endpoint or effectively strand them.

To mitigate issues in address handling, conventional approaches may implement central models that aggregate funds in centralized wallets and update internal ledgers when transferring between account identifiers. Balances are typically tracked on an internal database, not the public ledger, so transfers are credit-debit entries until the custodian decides to settle on-chain. The centralized tracking transactions create cybersecurity risk. Assets are commingled. Accordingly, central custodial systems are a high-value attack surface. For example, private keys that are used to access blockchain addresses are controlled by a centralized entity, making theft, insider abuse, or misconfiguration catastrophic. For example, faulty key management and liquidity mismatches can cascade into broad losses for users associated with the custodian. Moreover, centralized constrains functionality for the blockchain assets. The centralized approach may limit blockchain assets to supported networks and tokens, reducing composability with smart contracts. Central approaches introduce single points of failure and policy-driven control, which blockchain was designed to minimize.

### SUMMARY

In some aspects, the techniques described herein relate to a computer-implemented method, including: receiving a request to transfer a quantity of blockchain unit to an unregistered phone number; creating a cryptographic custody of the quantity of blockchain unit for the unregistered phone number to access, the cryptographic custody including a blockchain address that has a record of holding the quantity of the blockchain unit and a cryptographic signing key corresponding to a signer of the blockchain address, wherein creating the cryptographic custody includes: deterministically calculating the blockchain address of a smart account wallet based on the unregistered phone number, and creating a version of the cryptographic signing key corresponding to the signer of the smart account wallet; transmitting a notification to the unregistered phone number to access the cryptographic custody, the notification including a URL; receiving an indication that a device associated with the unregistered phone number has interacted with the URL; and causing a transmission of cryptographic signing key material to the device to enable the device to have cryptographic control over the smart account wallet.

In some aspects, the techniques described herein relate to a computer-implemented method, wherein determining the blockchain address based on the unregistered phone number is completed prior to the blockchain address is activated on a blockchain.

In some aspects, the techniques described herein relate to a computer-implemented method, wherein determining the blockchain address based on the unregistered phone number includes: generating a cryptographic salt based on the unregistered phone number; and precomputing, prior to the blockchain address being registered on a blockchain, the blockchain address by using a blockchain address generator.

In some aspects, the techniques described herein relate to a computer-implemented method, wherein generating the cryptographic salt includes: applying a server secret key to a version of the unregistered phone number, the server secret key associated with a server; and generating the cryptographic salt based on the server secret key applying to the version of the unregistered phone number so that the cryptographic salt is deterministic with respect to the server.

In some aspects, the techniques described herein relate to a computer-implemented method, further including performing recipient name confirmation.

In some aspects, the techniques described herein relate to a computer-implemented method, wherein the version of the cryptographic signing key includes a shard of the cryptographic signing key in a multi-party computation.

In some aspects, the techniques described herein relate to a computer-implemented method, further including performing one or more of SIM-swap detection, SIM age checks, and carrier auth.

In some aspects, the techniques described herein relate to a computer-implemented method, further including registering the unregistered phone number as a blockchain custodian of the quantity of blockchain unit.

In some aspects, the techniques described herein relate to a computer-implemented method, further including determining whether phone number is linked to a bank and selecting settlement path from: (a) external off-ramp, (b) bank omnibus crypto account, (c) embedded non-custodial wallet in bank app.

In some aspects, the techniques described herein relate to a computer-implemented method, wherein the blockchain unit is stablecoin.

In some aspects, the techniques described herein relate to a computer-implemented method, further including performing phone number compliance verification for cross-border transfer.

In some aspects, the techniques described herein relate to a computer-implemented method, wherein access to the blockchain address includes accessing a bank-embedded, non-custodial wallet.

In some aspects, the techniques described herein relate to a system, including: one or more processors; and memory storing code including instructions, wherein the instructions, when executed by the one or more processors, cause the one or more processors to: receive a request to transfer a quantity of blockchain unit to an unregistered phone number; create a cryptographic custody of the quantity of blockchain unit for the unregistered phone number to access, the cryptographic custody including a blockchain address that has a record of holding the quantity of the blockchain unit and a cryptographic signing key corresponding to the blockchain address, wherein creating the cryptographic custody includes: deterministically calculating the blockchain address of a smart account wallet based on the unregistered phone number, and creating a version of the cryptographic signing key corresponding to a signer of the smart account wallet; transmit a notification to the unregistered phone number to access the cryptographic custody, the notification including a URL; receive an indication that a device associated with the unregistered phone number has interacted with the URL; and cause a transmission of cryptographic signing key material to the device to enable the device to have cryptographic control over the smart account wallet.

In some aspects, the techniques described herein relate to a system, wherein determining the blockchain address based on the unregistered phone number is completed prior to the blockchain address is activated on a blockchain.

In some aspects, the techniques described herein relate to a system, wherein the instructions to determine the blockchain address based on the unregistered phone number include instructions to: generate a cryptographic salt based on the unregistered phone number; and precompute, prior to the blockchain address being registered on a blockchain, the blockchain address by using a blockchain address generator.

In some aspects, the techniques described herein relate to a system, wherein the instructions to generate the cryptographic salt includes instructions to: apply a server secret key to a version of the unregistered phone number, the server secret key belonging to a server; and generate the cryptographic salt based on the server secret key applying to the version of the unregistered phone number so that the cryptographic salt is deterministic with respect to the server.

In some aspects, the techniques described herein relate to a system, wherein the instructions to generate the cryptographic salt includes instructions to perform recipient name confirmation.

In some aspects, the techniques described herein relate to a system, wherein the version of the cryptographic signing key includes a shard of the cryptographic signing key in a multi-party computation.

In some aspects, the techniques described herein relate to a system, wherein the instructions, when executed by the one or more processors, further cause the one or more processors to register the unregistered phone number as a blockchain custodian of the quantity of blockchain unit.

In some aspects, the techniques described herein relate to a non-transitory computer-readable medium storing computer code including instructions, wherein the instructions, when executed by one or more processors, cause the one or more processors to: receive a request to transfer a quantity of blockchain unit to an unregistered phone number; create a cryptographic custody of the quantity of blockchain unit for the unregistered phone number to access, the cryptographic custody including a blockchain address that has a record of holding the quantity of the blockchain unit and a cryptographic signing key corresponding to a signer of the blockchain address, wherein creating the cryptographic custody includes: deterministically calculating the blockchain address of a smart account wallet based on the unregistered phone number, and creating a version of the cryptographic signing key corresponding to the signer of the smart account wallet; transmit a notification to the unregistered phone number to access the cryptographic custody, the notification including a URL; receive an indication that a device associated with the unregistered phone number has interacted with the URL; and cause a transmission of cryptographic signing key material to the device to enable the device to have cryptographic control over the smart account wallet.

### BRIEF DESCRIPTION OF THE DRAWINGS

FIG. 1 is a block diagram that illustrates a system environment of an example computing server, in accordance with some embodiments.

FIG. 2 illustrate various components of an example computing server, in accordance with some embodiments.

FIG. 3 is event flow diagram illustrating the actions and communications of an event flow performed by various components in sending cryptocurrency without custody by a centralized server, in accordance with some embodiments.

FIG. 4 is a flowchart illustrating a process for sending cryptocurrency without custody by a centralized server, in accordance with some embodiments.

FIG. 5 is a conceptual diagram illustrating an example graphical user interface (GUI) that is part of a platform provided by the computing server, in accordance with some embodiments.

FIG. 6A is a block diagram illustrating a chain of transactions broadcasted and recorded on a blockchain, in accordance with some embodiments.

FIG. 6B is a block diagram illustrating a connection of multiple blocks in a blockchain, in accordance with some embodiments.

FIG. 7 is a block diagram illustrating components of an example computing machine that is capable of reading instructions from a computer-readable medium and execute them in a processor (or controller).

The figures depict, and the detail description describes, various non-limiting embodiments for purposes of illustration only.

### DETAILED DESCRIPTION

The figures (FIGs.) and the following description relate to preferred embodiments by way of illustration only. One of skill in the art may recognize alternative embodiments of the structures and methods disclosed herein as viable alternatives that may be employed without departing from the principles of what is disclosed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

The disclosed system enables the transfer of value to any phone number, even when the recipient has not installed a wallet application. A sender enters the phone number and amount, and the system resolves and delivers the value through either on-chain stablecoin settlement or direct fiat settlement via an associated financial institution. In particular, this disclosure describes an approach to send cryptocurrency to a user in a non-custodial way that creates a blockchain address for the user to truly hold the cryptocurrency without custody by a centralized server. In some cases, a user can receive a quantity of blockchain unit at a pre-computed blockchain address by using an application executing on a user device having a phone number associated with the blockchain address—even if the recipient has yet to set up a wallet. In this way, the recipient receives a notification that may have a secure link to access the funds. Behind the scenes, the system uses a deterministic address generation method, so the wallet address is known in advance, allowing the sender to send a quantity of blockchain unit before accessing while preventing outsiders from guessing every number's address or balance. In some cases, the quantity of blockchain unit is stored at the blockchain address until the recipient later authenticates and starts using the wallet. As described herein, the approach disclosed is non-custodial by restricting a central server from holding the private key. As described herein, multi-party computing (MPC) is used to facilitate the non-custodial approach. For example, the private key is split into three shards (device, auth, recovery), and the user's device obtains access to two of those shards to sign a transaction. In this way, the provider does not hold the shards and therefore cannot move funds.

The system can perform cross-border payments between phone numbers in different jurisdictions. For example, when a recipient's number is linked to a banking endpoint, a computing server automatically performs conversion between fiat and stablecoins and triggers off-ramp settlement through banking rails, allowing receipt of local currency in the recipient's bank account while maintaining non-custodial cryptographic control during transfer. Moreover, to keep phone-number addressing safe, the aspects of the disclosure describe telco-grade checks before allowing a number to send or receive. The system may scan for subscriber identity module (SIM)-swap risk, SIM age, and in some regions network/internet protocol (IP)-level identifiers and uses one-time passcode (OTP) or OTP-less carrier verification to confirm control of the number. For example, an authenticator may generate an OTP as a cryptographically random one-time passcode (for example, six digits) to send to a recipient phone number for the recipient to prove authenticity. Aspects of the disclosure also describe screening on-chain activity and enforcing compliance policies when moving between crypto and traditional banking rails. If a phone number is linked to a bank, incoming stablecoins can be auto-converted and delivered via an external off-ramp, settled through a bank-controlled omnibus crypto account, or held/sent from a per-user non-custodial wallet embedded in the bank app, while the core on-chain transfers remain irreversible and non-custodial by design.

### System Overview

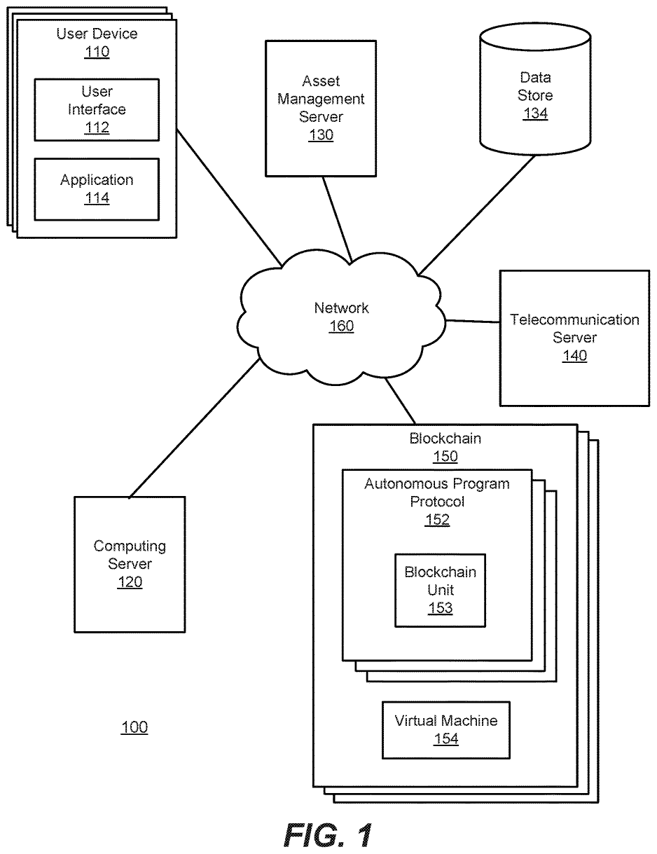

FIG. 1 is a block diagram that illustrates a system environment 100 of sending cryptocurrency to a user and creating a blockchain address for the user to truly hold the cryptocurrency without custody by a centralized server, in accordance with some embodiments. By way of example, the system environment 100 includes a user device 110, a computing server 120, an asset management server 130, data store 134, a telecommunication server 140, a blockchain 150, an autonomous program protocols 152, a blockchain unit 153, and a virtual machine 154. The entities and components in the system environment 100 communicate with each other through the network 160. In various embodiments, the system environment 100 may include different, fewer, or additional components. The components in the blockchain system environment 100 may each correspond to a separate and independent entity or may be controlled by the same entity. For example, in some embodiments, the computing server 120 may receive an instruction from a user device 110 to convert fiat currency stored by the asset management server 130 into cryptocurrency. In some cases, from a user perspective, the sender specifies the recipient's phone number and amount; the computing server 120 performs address derivation, asset conversion, transaction broadcast, and settlement routing transparently. In some cases, neither party interacts directly with blockchain parameters. The recipient is notified and receives local fiat or stablecoin credit depending on jurisdiction.

While each of the components in the system environment 100 is often described in disclosure in a singular form or plural form, the system environment 100 may include one or more of each of the components. For example, there can be multiple user devices 110 communicating with the computing server 120 and the blockchain 150. While a component is described in a singular form in this disclosure, it should be understood that in various embodiments the components may have multiple instances. Likewise, even if a component is frequently described in plural, there can be embodiments where only one instance of the component exists in the system environment 100. Hence, in the system environment 100, there can be one or more of each of the components.

A user device 110 may also be referred to as a client device. A user device 110 may be controlled by a user who may be the customers or users of the computing server 120, and/or a participant of the blockchain 150. In some situations, a user may also be referred to as an end user, for example, when the user uses applications that are published by the computing server 120. The user device 110 may be any computing device. Examples of user devices 110 include personal computers (PC), desktop computers, laptop computers, tablet computers, smartphones, wearable electronic devices such as smartwatches, or any other suitable electronic devices.

The user device 110 may include a user interface 112 and an application 114. The user interface 112 may be the interface (for example, frontend interface, application programming interface (API), etc.) of the application 114 and allow the user to perform various actions associated with application 114. In one example, the application 114 may be a software application that allows the user device 110, which is in possession of a blockchain wallet signing key, to interact with the blockchain 150. In another example, an application 114 may be a software application published by the computing server 120 that allows users to use various services provided by the computing server 120. In yet another example, an application 114 may be a portal that has access to the blockchain 150 to allow users to exchange various blockchain units with other users. In some embodiments, an application 114 is a software application that can be downloaded and installed on a user device 110 via, for example, an application store of the user device 110.

The possession of a blockchain wallet signing key may be through different forms. For example, in one case, the signing key may be stored in the memory (e.g., in a secure enclave environment) of a user device 110 that is possessed by the user. In another case, the signing key may be stored in shards in a distributed manner through techniques such as multi-party computation (MPC). In any case, regardless of the manner of storage of the signing key, it is considered that a user device 110 is in possession of the signing key.

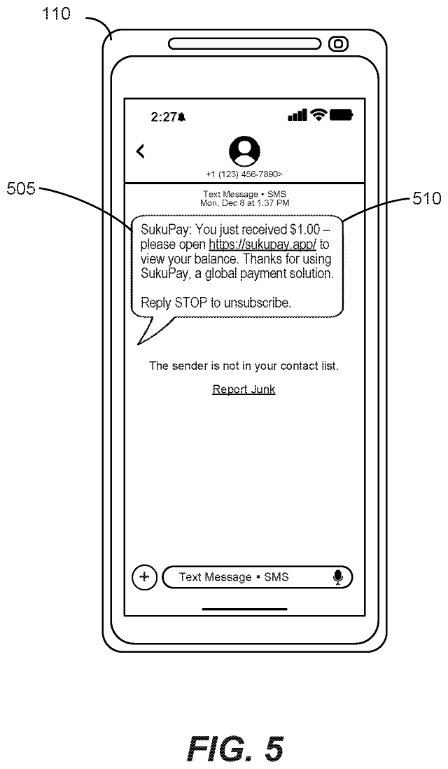

The user interface 112 may take different forms. In some embodiments, the user interface 112 is a software application interface. In some embodiments, the front-end software application may take the form of a webpage interface that allows users to perform actions through web browsers. The front-end software application includes a graphical user interface (GUI) that displays various information and graphical elements. In some embodiments, user interface 112 does not include graphical elements but communicates with the computing server 120 via other suitable ways such as command windows or application program interfaces. In some examples, the user interface 112 may include the display as shown in FIG. 5.

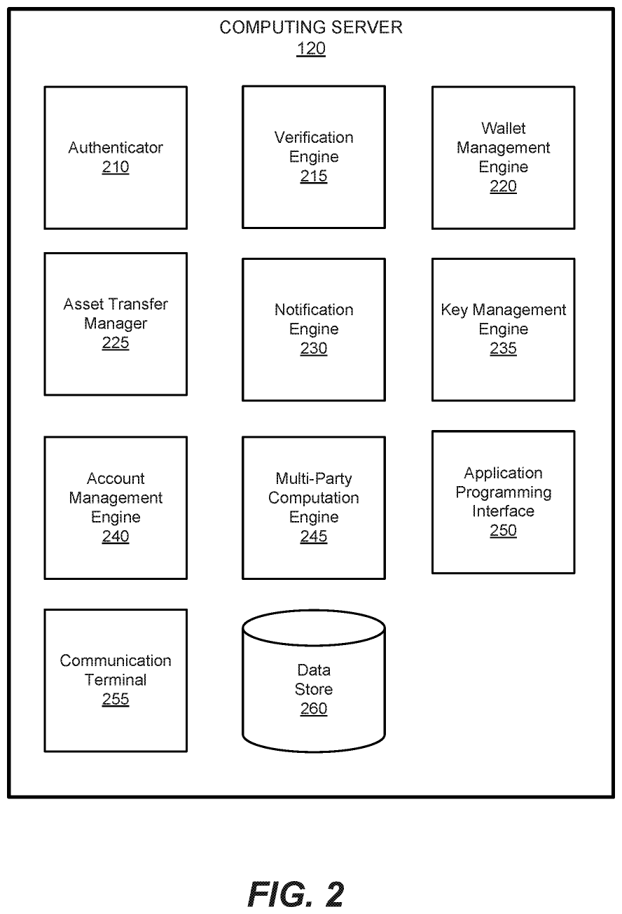

A computing server 120 may be a server that provides functionalities and services to users to allow users to send blockchain units to various users, such as a new user whose phone number may not have registered with the computing server 120. The computing server 120 creates a blockchain address for the receiving user to truly hold the cryptocurrency without custody by a centralized server, and other blockchain-related services. The computing server 120 may also be referred to as a remote server. While the computing server 120 is referred to as a server, for simplicity, the computing server 120 may also encompass a company that operates the computing server 120. The services provided by the computing server 120 may include access control (user authentication, authorization, and phone number verification), and other suitable compliance (such as Know Your Customers (KYC)) services. The detail of the operations and sub-components of the computing server 120 will be further discussed in association with FIG. 2.

An asset management server 130 may be a financial institution that receives and provides funds associated with a transfer of cryptocurrency to a user. In some embodiments, the asset management server 130 may be a retail/commercial bank or other licensed financial institution handling fiat custody and settlement. The asset management server 130 may manage account information associated with the users. For example, the account information may include account balances, posting of credits and/or debits to customer accounts, transaction histories, account identifiers, and/or the like. The asset management server 130 may store the account information in the data store 134. In some cases, the asset management server 130 may provide a customer account for a user to deposit and/or withdraw funds. In some cases, the asset management server 130 may receive funds deposited by the user that may be sent to another user (such as fiat) by on-ramping the funds to the customer account. On-ramping of funds may be converting money from fiat rails (such as from a bank account, card payment, ACH, and/or the like) into blockchain units (such as, on-chain stablecoins, for example, USDC) and depositing the blockchain units to a blockchain address associated with another user. In this way, the deposited funds may be sent to (and/or stored on) the blockchain 150. In some cases, the asset management server 130 may transfer the fiat to a third-party to mint blockchain units and transmit the blockchain units to the blockchain address of a recipient. In some cases, the asset management server 130 may convert the fiat to the blockchain unit within the customer account controlled by the asset management server 130. In this way, the asset management server 130 may receive the funds in the customer account (for example, via ACH/card payment) and converts the funds to blockchain units to provide to the blockchain address associated with the recipient user.

The asset management server 130 may provide funds to the recipient user by off-ramping the blockchain unit to fiat. Off-ramping may include converting the blockchain units (such as on-chain stablecoins, for example, USDC) into fiat and providing the funds via fiat rails to the customer account of the recipient. In some examples, the asset management server 130 may store converted funds in a cryptographic wallet managed by the asset management server 130. In some cases, the asset management server 130 may perform conversion of the fiat for the blockchain units (and/or from the blockchain units to fiat). In another example, the asset management server 130 may provide the fiat to an external conversion provider to perform conversion and receive the converted funds (in the blockchain units) from the external conversion provider. The asset management server 130 may apply credits (and/or debits) to the customer account to reflect the changes in a quantity of blockchain units for a particular user. In some embodiments, the asset management server 130 may provide access to a non-custodial wallet to a user through an application of the asset management server 130. In this way, the application of the asset management server 130 may include an embedded component (such as an iframe in HTML code) that includes access information associated with the user (such as, identifying information, a portion of a signing key to access a wallet associated with the user, and/or the like). In this way, the asset management server 130 may provide access to the non-custodial wallet without managing the wallet itself.

A telecommunication server 140 may provide messaging services between users to provide a notification associated with a transfer of cryptocurrency to a user that creates a blockchain address for the user to hold the cryptocurrency without custody by a centralized server. The telecommunication server 140 may be operated by one or more telecom providers to send a notification to a user device 110. The telecom providers may be GSMA partners, AT&T, VERIZON, SPRINT, T-MOBILE, and/or the like. In some cases, the telecommunication server 140 may send the notification to a phone number associated with the user device 110 (for example, the user of the user device 110 is the recipient of fund transfer). In some cases, the notification may include an alert indicating the user received a transfer of funds (such as, “you just received $1.00—please open the following link to view your balance: https://pay.app/”) via telecom channels, a one-time passcode (OTP) for authenticating the phone number, and/or the like. In some cases, the notification may include a URL that provides access to a wallet associated with the phone number. In some embodiments, the telecommunication server 140 may provide the notification via one or more messaging channels. For example, the messaging channels may include SMS, VoIP (such as third-party applications), application programming interface calls, instant messaging (such as WHATSAPP, WECHAT, FACEBOOK messaging), other channels such as email or voice call, and/or the like. The telecommunication server 140 may provide telecommunication metadata associated with the phone number to the computing server 120 to perform vetting of the phone number to ensure safe transferring of funds. The telecommunication metadata may include SIM-swap status, SIM age, Internet Protocol identifiers associated with the phone number, spoof identifier, and/or the like.

While each of the servers 120, 130, and 140 is described in a singular form, a computing server (e.g., computing server 120, asset management server 130, telecommunication server 140) may include one or more computers that operate independently, cooperatively, and/or distributedly. For example, in various embodiments, a computing server may take different suitable forms. In some embodiments, a computing server may be a server computer that includes one or more processors and memory that stores code instructions that are executed by the one or more processors to perform various processes described herein. In some embodiments, a computing server may be a pool of computing devices that may be located at the same geographical location (for example, a server room) or be distributed geographically (for example, cloud computing, distributed computing, or in a virtual server network). In some embodiments, a computing server may be a collection of servers that independently, cooperatively, and/or distributedly provide various products and services described in this disclosure. A computing server may also include one or more virtualization instances such as a container, a virtual machine, a virtual private server, a virtual kernel, or another suitable virtualization instance. A computing server may provide users and/or user devices 110 with various blockchain services as a form of nodes in addition to cloud-based software, such as software as a service (SaaS), through the network 160.

A blockchain 150 may be a public blockchain that is decentralized, a private blockchain, a semi-public blockchain, an execution layer settling data on a public blockchain (for example, Layer 2 blockchains, rollups), or an application-specific chain. A public blockchain network includes a plurality of nodes that cooperate to verify transactions and generate new blocks. In some implementations of a blockchain, the generation of a new block may also be referred to as a proposal process, which may be a mining process or a validation process. A blockchain 150 may be a new blockchain or an existing blockchain such as BITCOIN, ETHEREUM, EOS, NEAR, SOLANA, AVALANCHE, etc. The system environment 100 may include one or more blockchains 150. In some embodiments, the process described in this disclosure may allow cross-chain communications. In other embodiments, the on-chain processes described in this disclosure are conducted with a single blockchain 150. A blockchain 150 may include a plurality of nodes. Each node may include one or more processors. The processors in various nodes may independently or cooperatively execute various blockchain processes such as generating blocks, reaching consensus, and executing code instructions that are stored on the blockchain 150.

Some of the blockchains 150 support one or more autonomous program protocol 152, which is a set of code instructions that are stored on a blockchain 150 and are executable when one or more conditions are met. The autonomous program protocols 152 may be smart contracts, Web3 applications, autonomous applications, distributed applications, decentralized finance (DeFi) applications, protocols for decentralized autonomous organizations (DAO), non-fungible tokens (NFT), decentralized exchanges, identity services, blockchain gaming, metaverse protocols, and other suitable protocols and algorithms that may be recorded on a blockchain. Smart contracts may be examples of autonomous program protocols 152 that may be executable by a computer such as a virtual machine 154 of the blockchain 150. Here, a computer may be a single operation unit in a conventional sense (e.g., a single personal computer) or may be a set of distributed computing devices that cooperate to execute the code instructions (e.g., a virtual machine or a distributed computing system). An autonomous program protocol 152 includes a set of instructions. The instructions, when executed by one or more processors, cause the one or more processors to perform steps specified in the instructions. The one or more processors may correspond to a node of the blockchain 150 or may be distributed among various nodes of the blockchain 150.

A blockchain unit 153 may be any blockchain resources such as cryptocurrency, coins (including stable coins), or tokens that are generated and/or exchanged on a blockchain 150, such as BITCOIN, ETHER, TETHER, BINANCE COIN, US DOLLAR COIN, XRP, CARDANO, DOGECOIN, SOLANA, LITECOIN, etc., and verifiable credentials that are signed into the blockchain 150 by a wallet or on behalf of a wallet. Blockchain resources may also include but are not limited to tokens, non-fungible tokens, fungible tokens, soulbound tokens, wrapped tokens, signed tokens, vault tokens, pool tokens, non-standard format on-chain available data or functions, nonstandard format on-chain discoverable data or functions and any variations of them. Blockchain resources can include but are not limited to on-chain available resources that refer to a blockchain address or a resource that is owned or controlled by a blockchain address. Other example units may include any fungible tokens that comply with the ERC-20 standard and non-fungible tokens such as those generated under ERC-721 standard.

The data store 134 includes one or more storage units such as memory that takes the form of non-transitory and non-volatile computer storage medium to store various data. The computer-readable storage medium is a medium that does not include a transitory medium such as a propagating signal or a carrier wave. The data store 134 may be used by the computing server 120 to store data related to the interaction between the computing server 120 and the user devices 110, such as transfer requests, creation of the blockchain addresses for the user (for example, cryptographic salts), and/or the like. In some embodiments, the data store 134 communicates with other components by the network 160. This type of data store 134 may be referred to as a cloud storage server. Example cloud storage service providers may include AMAZON AWS, DROPBOX, RACKSPACE CLOUD FILES, AZURE BLOB STORAGE, GOOGLE CLOUD STORAGE, etc. In another embodiment, instead of a cloud storage server, the data store 134 is a storage device that is controlled and connected to the computing server 120. For example, the data store 134 may take the form of memory (e.g., hard drives, flash memory, discs, ROMs, etc.) used by the computing server 120 such as storage devices in a storage server room that is operated by the computing server 120.

The communications among various components in the system environment 100 may be transmitted via a network 160, for example, via the Internet. In some embodiments, the network 160 uses standard communications technologies and/or protocols. Thus, the network 160 can include links using technologies such as Ethernet, 802.11, worldwide interoperability for microwave access (WiMAX), 3G, 4G, LTE, 5G, digital subscriber line (DSL), asynchronous transfer mode (ATM), InfiniBand, PCI Express Advanced Switching, etc. Similarly, the networking protocols used on the network 160 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 160 can be represented using technologies and/or formats including the hypertext markup language (HTML), the extensible markup language (XML), etc. In addition, all or some of the links can be encrypted using conventional encryption technologies such as secure sockets layer (SSL), transport layer security (TLS), virtual private networks (VPNs), Internet Protocol security (IPsec), etc. The network 160 also includes links and packet switching networks such as the Internet.

### Example Computing Server

FIG. 2 is a block diagram representing an example computing server 120, in accordance with some embodiments. In the embodiment shown in FIG. 2, the computing server 120 includes authenticator 210, verification engine 215, wallet management engine 220, asset transfer manager 225, notification engine 230, key management engine 235, account management engine 240, multi-party computation engine 245, application programming interface 250, communication terminal 255, and data store 260. The functions of the computing server 120 may be distributed among different components in a different manner than described below. Also, in various embodiments, the computing server 120 may include different, fewer, and/or additional components.

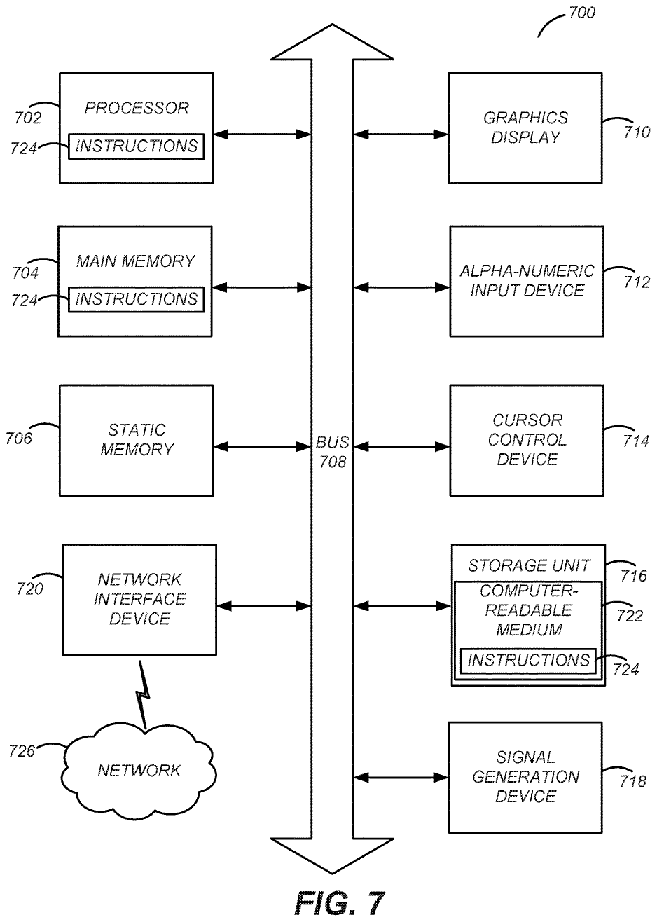

While the computing server 120 is used in a singular form, the computing server 120 may include one or more computers that include one or more processors and memory. The memory may store computer code that includes instructions. The instructions, when executed by one or more processors, cause the processors to perform one or more processes described herein. The computing server 120 may take different forms. In some embodiments, the computing server 120 is a single computer that executes code instructions directly. In some embodiments, the computing server 120 is a group of computing devices that communicate with each other. The computing devices may be located geographically at the same (e.g., in a server room) or in different locations. In some embodiments, the computing server 120 includes multiple nodes that operate in a distributed fashion such as in cloud computing or distributed computing. Each node may include one or more computing devices operating together. In some cases, the computing server 120 may also include virtual machines. In some embodiments, each component in FIG. 2 may be operated by a separate server and the computing server 120 may serve as the collective term of those servers. Any computing devices, nodes, or virtual machines, singular or plural, may simply be referred to as a computer, a computing device, or a computing server. Components of the computing server 120 shown in FIG. 2, individually or in combination, may be a combination of hardware and software and may include all or a subset of the example computing system illustrated and described in FIG. 7.

An authenticator 210 may authenticate information associated with a user. The authenticator 210 may receive a phone number to perform authentication. The authenticator 210 may normalize the phone number to E.164 and select an authentication mode. For example, the verification mode may include OTP, OTP-less network-based telco authentication, and/or the like. In the OTP method, the authenticator 210 may generate a cryptographically random one-time passcode (for example, six digits). The authenticator 210 may generate and store a time-to-live (TTL) and attempt counter that may used to invalidate authentication attempts. The authenticator 210 may send the passcode to the phone number (for example, via notification engine 230). The user device 110 may submit the passcode in an application of the computing server 120. The authenticator 210 may authenticate the entered passcode against the stored passcode. The authenticator 210 may compare a time to respond by the phone number to the TTL and the attempt counter. The authenticator 210 may determine the attempt is successful if the response by the phone number is within the TTL, attempts are below an attempt counter threshold, and matches the stored passcode. In response to the attempt being successful, the authenticator 210 may update authentication indicator that the phone number passed authentication. In the OTP-less flow, the authenticator 210 may invoke a carrier verification application programming interface to confirm control of the phone number using the telecommunication metadata, for example, from the verification engine 215.

In some embodiments, the authenticator 210 may provide step-up security (such as, passkey, biometric, and/or the like). The authenticator 210 may request the user to complete passkey authentication. A passkey may be a device-bound cryptographic login credential that lets a user authenticate with another approach (such as biometrics or a PIN) rather than a password. In some embodiments, the authenticator 210 implements a passkey-based factor using a WebAuthn/FIDO2 workflow integrated with computing server 120 and data store 260.

In some embodiments, the authenticator 210 may perform multifactor authentication. For example, the authenticator 210 may perform two factor authentication (TFA). The authenticator 210 may perform TFA by enforcing two distinct factors prior to authentication of the user device 110. In some cases, the authenticator 210 may invoke a first factor that may provide authentication by verifying control of the user device 110. For example, the authenticator 210 may send an OTP to the phone number and validating a returned code within a TTL and a retry limit. In some cases, the authenticator 210 may invoke a second factor that involves, for example, a passkey/biometric feature. In response to successful completion of both the first factor and the second factor, the authenticator 210 may indicate the phone number is authentic. In this way, the authenticator 210 may cause release of the authentication shard.

The authenticator 210 may request the user to complete biometric authentication. Biometric authentication may be use of a physical trait, such as fingerprint or face scan, to prove authenticity of the user. The computing server 120 issues a fresh, cryptographically random challenge and session context to the user device 110. The user device 110 invokes a platform authenticator (e.g., Face ID/Touch ID on iOS or Android BiometricPrompt) to either (i) unlock a device-managed key (e.g., Secure Enclave/Keychain or Android Keystore) and sign the challenge, or (ii) use a WebAuthn/FIDO2 passkey to produce an assertion over the challenge, origin, and relying-party ID. The computing server 120 verifies the returned signature/assertion against a previously registered public key (credentialId), checks origin/RP binding and a monotonic counter to prevent replay, and enforces user-verification flags from the authenticator 210. Upon successful authentication, the authenticator 210 marks the session as biometric-verified and permits release of the authentication key share to the device 110 over an authenticated, encrypted channel; the full private key is never assembled on a centralized server, and subsequent transaction signing occurs via on-device threshold reconstruction.

The verification engine 215 may perform verification of the phone number before onboarding a phone number that is not registered with the computing server 120. The verification engine 215 may query a telecommunication provider (such as via the telecommunication server 140) to obtain telecommunication metadata. For example, the verification engine 215 may integrate with the telecommunication server 140 to send and receive application programming interface calls associated with the telecom carriers (for example, via the application programming interface 250 to GSMA, and/or the like). The verification engine 215 may obtain telecommunication metadata, such as (i) SIM-swap status with an indicator and/or event timestamp (for example, whether a recent SIM change occurred), (ii) SIM age (days since the last activation or issuance), and (iii) a network-level identifier associated with the line. In some cases, the telecommunication metadata may include an IP-level identifier and spoofing-detection flags. The verification engine 215 may evaluate the telecommunication metadata to generate an eligibility indicator for the phone number (accept/deny/step-up). In some cases, the eligibility indicator may include denying use in response to a SIM swap is flagged within a predetermined quantity of days, requiring step-up if SIM age is below a predetermined quantity of days, and allowing otherwise with risk-based limits.

In some cases, the verification engine 215 may obtain results from the authenticator 210 (for example, OTP success/failure or an OTP-less carrier-verified assertion). In some cases, the verification engine 215 may obtain on-chain analytics to verify the phone number. The on-chain analytics may include: sanctions screening, exposure to malicious clusters, flow analysis, behavioral anomalies, cluster association, provider risk score, and/or the like. In some cases, the verification engine 215 may obtain sanctions screening associated with the phone number. The sanctions screening may include a check of the phone number appears on a sanctions lists (such as OFAC) or other anti-money laundering (AML) or politically exposed persons (PEP) watchlists. The exposure to malicious clusters may include detecting association of the phone number to exploits, scams, mixers, and other high-risk services using cluster/entity intelligence from analytics providers (such as KYT feeds). The flow analysis may include a measure of a percentage of inbound/outbound value associated with known-bad addresses and proximity by hop count and flag if flow exceeds a threshold. The behavioral anomalies may include review for suspicious patterns (rapid bursts, peel chains, circular flows) that indicate laundering or bot activity. The cluster association may include identifying the phone number is associated with known entities (such as exchanges, mixers, DeFi protocols) and assess proximity to illicit clusters. The provider risk scores may include normalized scores (such as 0-100 or low/medium/high) and reason codes from one or more analytics providers.

KYC and AML are compliance features for the computing server 120 that verify identity and screen for illicit activity associated with the unregistered phone number when conversion of blockchain units to fiat (and conversely from fiat to blockchain units). The computing server 120 may implement KYC in response to on-ramp (and/or off-ramp) events and may rely on government ID checks, liveness/video capture, and address verification. In response to successful verification, conversions between fiat and blockchain units may occur. AML may include the computing server 120 monitoring sanctions/AML watchlists and applies on-chain analytics to detect exposure to malicious wallets, uses device/behavioral fraud tools, and enforces transaction limits. In some cases, fiat services are denied if these checks fail.

A wallet management engine 220 may generate a blockchain address according to the phone number of a recipient. In some cases, the generation of the blockchain address may rely on a cryptographic salt (and additional information, such as a bytecode). In this way, the wallet management engine 220 may generate a per-number cryptographic salt. In some cases, the wallet management engine 220 may apply a server secret key, salt, pepper, or a combination, to a version of an unregistered phone number (the server secret key belonging to a server). The unregistered phone number may be any phone number that is a target for receiving funds but has not been registered with the computing server 120 or has a blockchain address associated with the phone number. The unregistered phone number may be global identifiers, including country codes, and are not limited to a single jurisdiction or domestic network. The funds may be in the form of transferring a quantity of blockchain unit to a wallet associated with the unregistered phone number. In some cases, the unregistered phone number may not have a digital wallet established to transfer the quantity of blockchain units associated with the transfer of funds (no device shard created, no on-chain wallet code deployed, and no existing account profile). For example, a first user may initiate a transfer of funds to a second user (such as the first user gifting $1.00 to the second user). The first user may identify a destination to provide the funds as a phone number associated with the second user. The phone number may have no corresponding digital wallet and is thus unregistered.

The wallet management engine 220 may generate the cryptographic salt based on the unregistered phone number so that the cryptographic salt is deterministic with respect to the phone number. In some examples, the wallet management engine 220 may generate the cryptographic salt by using an oblivious pseudorandom function (OPRF). The wallet management engine 220 may provide the unregistered phone number to the OPRF that returns a deterministic, pseudo-random salt (for example, 32-bytes) associated with the unregistered phone number. The wallet management engine 220 may precompute the blockchain address before generating a corresponding wallet, for example, by providing as input the cryptographic salt and bytecode to a blockchain address generator (such as EVM CREATE2). In this way, the computing server 120 may allow a quantity of blockchain unit to be sent to the blockchain address prior to the recipient user has set up the wallet. In some cases, the wallet management engine 220 does not prebuild addresses for all phone numbers, the wallet management engine 220 generates the blockchain address on demand in response to a transaction references the unregistered phone number. The wallet management engine 220 may cache the OPRF output and computed address in data store 260.

In some cases, in response to a wallet being created for the unregistered phone number, the wallet management engine 220 may generate the blockchain address associated with the unregistered phone number. For example, generation of the wallet may include the wallet management engine 220 causing execution of the autonomous program protocol 152 to generate the wallet at the blockchain address via the virtual machine 154. In this way, the generation of the wallet may cause the computing server 120 to generate the blockchain address associated with the blockchain wallet. The autonomous program protocol 152 may set signing policy for the wallet that relies on MPC key shards. The blockchain address may correspond to a quantity of blockchain unit 153 on the blockchain 150 and may receive token transfers before deployment, with deployment executed by the virtual machine 154.

In some cases, the wallet management engine 220 may generate the blockchain address using various forms of pseudorandom value generation. For example, alternative deterministic constructions may include a server-side keyed PRF (e.g., HMAC-SHA256 and HKDF to 32 bytes), a verifiable random function (VRF) that produces a pseudorandom salt with a proof, a multi-party PRF aggregation where outputs from several keyed services are concatenated and hashed to form the final salt, and other keyed PRFs/KDFs such as KMAC256, BLAKE3 keyed mode, AES-CMAC, or NIST SP 800-108 counter-mode KDF. In some examples, domain separation (binding to bytecode), key rotation by epoch with published commitments, and on-demand derivation (rather than prebuilding all numbers) are employed to preserve determinism, after which the cryptographic salt may be used with the bytecode in EVM CREATE2 to compute the blockchain address.

An asset transfer manager 225 may build and submit on-chain blockchain unit transactions from the sender's wallet to the recipient's deterministically derived blockchain address. In some cases, before submission, the asset transfer manager 225 may cause the user device 110 to assemble a version of a signing key on-device, to produce a signature, and return a raw signed transaction for broadcast. In some cases, after submitting the transaction, the asset transfer manager 225 may apply routing rules. For example, if the recipient's phone number is linked to a bank, the asset transfer manager 225 may divert the flow to off-ramp and settle fiat (via an external off-ramp), to a bank crypto account with internal conversion, or to a per-user wallet embedded in the bank app, or leave the quantity of blockchain unit on-chain. The asset transfer manager 225 may coordinate conversion and settlement notifications to the asset management server 130 for ledger credits/debits, triggers user notifications via the notification engine 230 (e.g., SMS/WHATSAPP), and persists status/telemetry in the data store 260 for auditing and compliance.

The asset transfer manager 225 may cause execution of smart contract code stored on the blockchain to transfer funds. For example, the asset transfer manager 225 may trigger execution of smart contract code stored on the blockchain by submitting a transaction that calls a function of the smart contract. In some cases, the asset transfer manager 225 can construct and submit a signed transaction that calls a designated function of a deployed smart contract. For example, responsive to the blockchain validates and includes a transaction directed to the blockchain address, corresponding smart contract code is executed to initiate a transfer of funds. In response to validator nodes of the blockchain confirm and include the transaction in a block, the Ethereum Virtual Machine (EVM) may execute the corresponding smart contract bytecode. The contract logic then updates the blockchain state, for example, initiating a programmed transfer of assets from the sender's address to a specified recipient. In some cases, the software code executed by the blockchain causes the funds to transfer from the sender to a recipient.

In some embodiments, asset transfer manager 225 may cause conversion of funds from an account associated with a recipient, for example, by off-ramping the blockchain unit to fiat. Off-ramping may include converting the blockchain units (such as on-chain stablecoins, for example, USDC) into fiat and providing the funds via fiat rails to the customer account of the recipient. In some examples, the asset management server 130 may store converted funds in a cryptographic wallet managed by the asset management server 130. In some cases, the asset management server 130 may perform conversion of the fiat for the blockchain units (and/or from the blockchain units to fiat). In another example, the asset management server 130 may provide the fiat to an external conversion provider to perform conversion and receive the converted funds (in the blockchain units) from the external conversion provider. The asset management server 130 may apply credits (and/or debits) to the customer account to reflect the changes in a quantity of blockchain units for a particular user. In some embodiments, the asset management server 130 may provide access to a non-custodial wallet to a user through an application of the asset management server 130. In this way, the application of the asset management server 130 may include an embedded component (such as an iframe in HTML code) that includes access information associated with the user (such as, identifying information, a portion of a signing key to access a wallet associated with the user, and/or the like). In this way, the asset management server 130 may provide access to the non-custodial wallet (for example, a bank-embedded, non-custodial wallet) without managing the wallet itself.

In some embodiments, the notification engine 230 may provide user-facing messages (for example, “funds received”) and verification codes (such as OTP codes). In some cases, the notification engine 230 may send user notifications about events (incoming transfer, request to access, status updates). The notification engine 230 may deliver and validate OTP for phone-number ownership verification where applicable. In some examples, the notification engine 230 may trigger programmatic notifications to internal/external components (for example, call application programming interfaces to asset management server 130, off-/on-ramp providers, and/or the like) to reflect state changes.

A key management engine 235 may store and manage one or more cryptographic signing keys for various users of user devices 110 to participate in various blockchains and to generate digital signatures for various blockchain operations such as transfers of blockchain units and requests to access autonomous program protocols 152. The key management engine 235 stores various versions of signing cryptographic keys of the users. The singing keys are typically private to the users. The various versions may be referred to as cryptographic key material. In some embodiments, the key management engine 235 may store a signing key by storing the string of the signing key secretly without MPC implementation. In such a case, the cryptographic key material may be the entirety of the signing key. In some embodiments, the version of the cryptographic signing key may include a shard of the cryptographic signing key in a multi-party computation. The shard in such a case would be the cryptographic key material. For example, the cryptographic signing key is divided into a plurality of key shards. In this way, a key management engine 235 may store a shard of a signing key for MPC. In some embodiments, upon retrieving the cryptographic key material (whether it is a shard in MPC implementation or the entirety of the signing key in non-MPC implementation), the key management engine 235 may generate a digital signature on behalf of a key owner. In some embodiments, the key management engine 235 may also have the capability of generating new cryptographic signing keys in key rotation or in a new user situation. For example, the user device 110 may have a new user and the key management engine 235 may generate a new key pair.

An account management engine 240 may maintain linkage between users (for example, phone numbers), blockchain addresses, and one or more customer account endpoints (such as accounts for an asset management server 130 such as a financial institute). In some cases, the account management engine 240 may store an account graph including one or more of a user identifier, an associated phone number, a blockchain address, wallet metadata (version/bytecode hash), an customer account identifier, a routing profile (for example, the routing profile indicating whether incoming or outgoing value should be delivered on-chain or settled in fiat through a financial institution), and/or the like. In response to receipt of a transfer request containing a recipient phone number and context information (for example, sender/recipient role), the account management engine 240 resolves the phone number to the corresponding on-chain destination and/or a bank-settlement path and emits a routing decision with parameters required for execution: for on-chain delivery, target chain identifier, token contract, and the blockchain address; for fiat settlement, endpoints for an external off-ramp provider, a bank crypto account (mint/burn) with internal conversion, or a per-user wallet embedded inside the bank's application. The account management engine 240 coordinates with the asset transfer manager 225 to instruct credits/debits at the financial institution when fiat settlement is selected, notifies the asset management server 130 to post ledger entries, and persists decision telemetry and audit artifacts in the data store 260.

In some embodiments, a multi-party communication (MPC) engine 245 provides or participates in MPC operations. The multi-party computation engine 245 may serve as a node in an MPC network where a group of nodes jointly perform computation without revealing the inputs of the nodes to each other. MPC may be used to securely generate a signing key. By using MPC, the signing key can be generated without any node possessing the entire key, thereby improving security and preventing any single point of failure. In some embodiments, the computation of a signing key may completely occur within a user device 110 so that the multi-party computation engine 245 operated by the computing server 120 is not involved. In some embodiments, the multi-party computation engine 245 operated by the computing server 120 may store the cryptographic key material (e.g., a version of a signing key) and the MPC is conducted using a user device 110 and the multi-party computation engine 245.

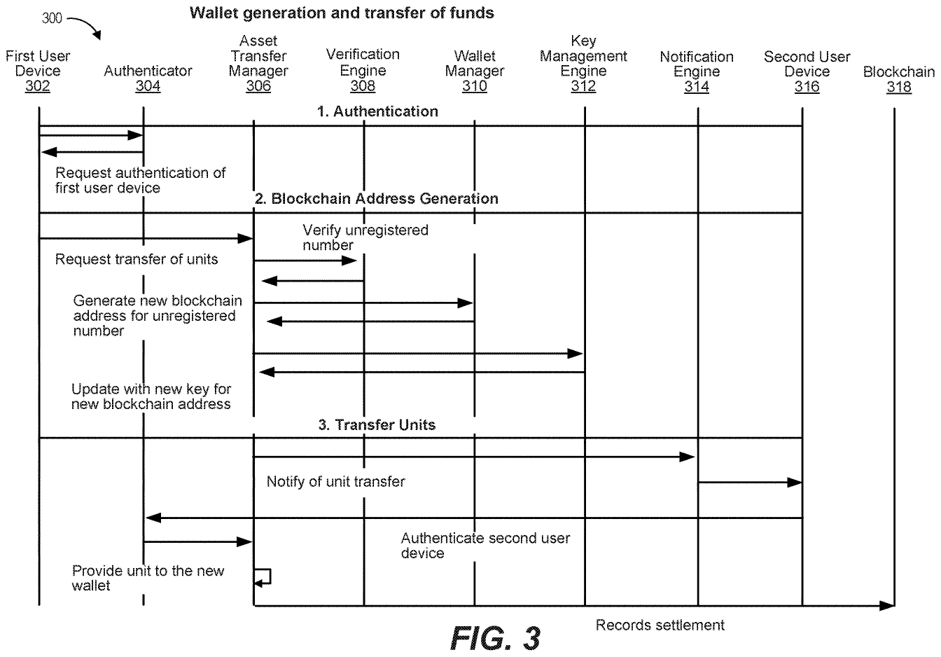

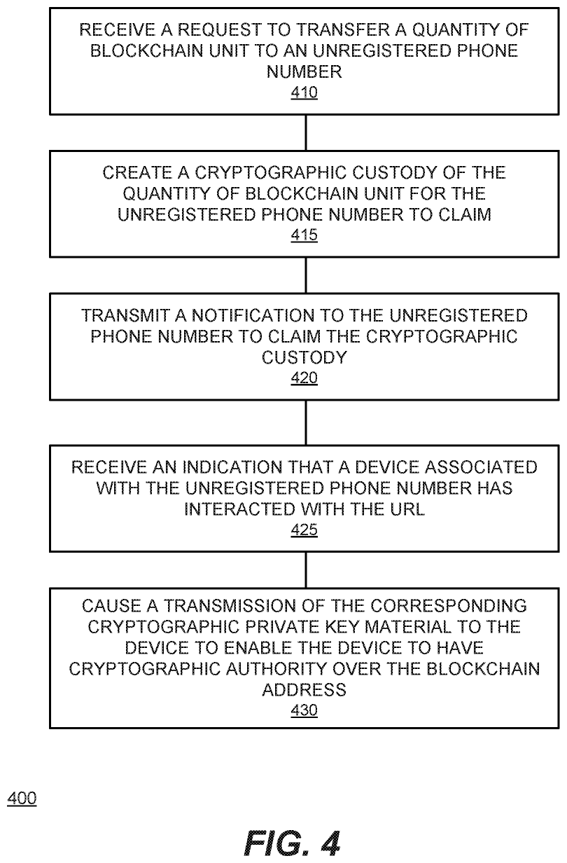

In some embodiments, in response to obtaining and accessing the blockchain address, a recipient associated with the unregistered phone number may cause a subsequent transfer of another quantity of blockchain unit by using the computing server 120. For example, the recipient may authorize a transaction with the cryptographic key material used to control the blockchain address (such as the shards associated with the multi-party computation engine 245). In some cases, the recipient's device may store (such as locally persisted in a secure enclave) the device shard created during access. In response to initiating a new transfer, the authenticator 210 may authorize release of the authentication shard to the recipient's device. In this way, the device may access the shards to produce a digital signature to create a new blockchain transaction initiated from the blockchain address. The digital signature may be generated by MPC using the key shards The computing server 120 may orchestrate execution of the transfer of the other quantity of blockchain unit (for example, as described herein in FIG. 3 and FIG. 4).

In some cases, the computing server 120 may perform blockchain operations for the transfer of the quantity of blockchain for a seamless user experience. The blockchain operations may include address derivation, transaction construction, signing, and submission behind an authenticated application workflow, thereby eliminating direct user interaction with blockchain-specific parameters such as nonce, gas estimation, fee tokens, and RPC/node selection. For example, in response to a user's request to transfer the quantity of blockchain unit, the wallet management engine 220 may compute the recipient's blockchain address for later deployment, while the asset transfer manager 225 may assemble the quantity of blockchain unit. In this way, the computing server may delegate the blockchain operations, such as network selection, fee estimation/sponsorship, and broadcasting to the communication terminal 255. In some cases, transaction authorization is based on using the cryptographic key material (such as a key shard in MPC with the multi-party computation engine 245) and returning the resulting signature to the computing server 120 for submission. In this way, execution may be carried out by the virtual machine 154 and recorded on the blockchain 150 (and components thereof). In this way, abstracting the blockchain operations may remove the blockchain operations from end users so the user experience remains simple.

In some embodiments, an application programming interface 250 allows a party to communicate with and access the functionalities of the computing server 120 directly through a programming language. For example, the computing server 120 may operate blockchain nodes, obtain a shard of the signing key, and store ledgers of blockchains 150. A user may query the information of a blockchain 150 through an application programming interface call. In some embodiments, a user may also conduct a blockchain operation through a blockchain node operated by the computing server 120. The user may use an application programming interface call to initiate the operation request. In some embodiments, a user may also subscribe to the application programming interface 250. For example, the notifications can be provided in the form of pull notifications by conventional application programming interface in which the recipient may continuously poll the application programming interface. In some embodiments, the notifications can be provided through webhook, which may be a form of push application programming interface notifications where the computing server 120 automatically transmit the application programming interface notifications to the recipient when a matching event has occurred. An application programming interface notification, such as a webhook notification, may include a header and a payload. The payload may be in the format of key-value pairs that are in the format of JSON, XML, YAML, CSV, or another suitable format.

In some embodiments, a communication terminal 255 of the computing server 120 may provide network and blockchain connections between the computing server 120 and various entities that communicate with the computing server 120. The computing server 120 may serve as a node of various blockchains to provide up-to-date information about the state of the blockchain. The computing server 120 may include different terminals such as blockchain terminal, asset exchange terminal, and messaging application terminal. Each terminal may manage a data feed or a webpage that publishes information regarding the related services and server status. Each terminal may also include its individual application programming interface.

In some embodiments, a data store 260 is a database that stores various information with respect to settings provided by customers of the computing server 120, such as user devices 110. The data stored may include profiles of users, settings of the users, and various policies associated with blockchain operations specified by the users. The data store 260 may also include or be in communication with a credential vault that stores user identifiers and passwords and the computing server 120 may perform authentication of a customer. The data store 260 may also store data and metadata related to various operations involving an autonomous program protocol 152. For example, the computing server 120 may have the functionalities of serving as blockchain nodes of various blockchains 150. Various information related to a blockchain 150, such as the full ledgers of the blockchain 150, may also be stored in data store 260 to allow an inquirer to query for information on the blockchain 150, such as through the application programming interface 250.

### Example Flow Diagram

FIG. 3 is an event flow diagram illustrating the actions and communications of an event flow 300 performed by various components in sending blockchain units (e.g., cryptocurrency) to a user in a non-custodial process that creates a blockchain address for the user to hold the cryptocurrency without custody by a centralized server, in accordance with some embodiments. While cryptocurrency such as stable coin is used as an example in FIG. 3, the process may be applied to other types of blockchain units in various embodiments. The components in the event flow 300 may include a first user device 302, authenticator 304, asset transfer manager 306, verification engine 308, wallet manager 310, key management engine 312, notification engine 314, second user device 316, and blockchain 318.

The authentication process establishes cryptographic proof that the first user device 302 controls the sender's phone number and is eligible to transfer a quantity of blockchain unit. The authentication process is in response to the authenticator 304 receiving a request to authenticate the first user device 302. In some cases, the authenticator 304 generates an authentication session bound to the phone number of the first user device 302 and selects an authentication modality (such as OTP or OTP-less carrier verification). The authenticator 304 may initialize an authentication session record containing fields such as session identifier, the phone number of the sender, authentication method, and/or the like. For an OTP flow, the authenticator 304 may generate an n-digit OTP code, set a TTL and max attempts, and deliver the OTP code (for example, via the notification engine 314 over SMS) to the phone number of the sender. The first user device 302 may return the OTP code to the authenticator 304, which validates the OTP code, TTL, and attempt limits. In response to successful validation of the OTP code, TTL, and attempt limits, the authenticator may indicate the phone number is successfully authenticated. For an OTP-less flow, the authenticator 304 may invoke a carrier verification application programming interface and obtain a signed assertion of possession of the phone number of the sender. In response to the authenticator 304 determining the first user device 302 is authenticated, the authenticator 304 updates an authentication indicator allowing the transfer of the quantity of blockchain unit.

In some examples, the process of transferring the quantity of blockchain unit may be without authentication of the first user device 302. For example, the first user device 302 may execute an application that allows the transfer of the quantity of blockchain unit. In this way, the authenticator 304 may identify the application as the source of the request to transfer the quantity of blockchain unit (for example, identifying information associated with the application from an application programming interface call to transfer the quantity of blockchain unit). In this way, the authenticator 304 may allow the transfer of the quantity of blockchain unit without authentication as described herein.

In some embodiments, the transfer of the quantity of blockchain unit may be cross-border transfers addressed by phone numbers in different countries. In this way, a sender associated with a first country code and area code can initiate a transfer to a recipient associated with a second, different country code and area code. The computing server 120 may perform verification of one or more of the phone numbers associated with the transfer of the quantity of blockchain (for example, performs telco risk/ownership checks per jurisdiction). In response to successful verification, the computing server 120 may invoke the wallet management engine 220 to compute the recipient's blockchain address irrespective of country, enabling the transfer across borders. The asset transfer manager 225 may select a supported blockchain and blockchain unit and submit the on-chain transfer. In some cases, the recipient may perform off-ramp of the quantity of blockchain unit, allowing, for example, a sender with a +1 (U.S.) number to deliver value to a recipient with a +55 (Brazil) number and convert the quantity of blockchain unit locally in fiat. Messaging via the telecommunication server 140 notifies the recipient at the foreign number, while KYC/AML controls are applied at on/off ramps according to the relevant jurisdictions, thereby enabling cross-border phone-number-addressed transfers with non-custodial wallet control and optional local bank delivery. In some embodiments, before the transferred is allowed, the computing server 120 may also perform compliance checks that are discussed below.

In some embodiments, the asset transfer manager 306 may receive (for example, via an application programming interface) a request to transfer the quantity of a blockchain unit to a recipient associated with an unregistered phone number (for example, second user device 316). The unregistered phone number may be any phone number that is a target for receiving funds but has not been registered with the computing server 120 or has an associated blockchain address on the blockchain 150. The funds may be in the form of transferring a quantity of blockchain unit to a wallet associated with the unregistered phone number. In some cases, the unregistered phone number may not have a digital wallet established to transfer the quantity of blockchain units associated with the transfer of funds (no device shard created, no on-chain wallet code deployed, and no existing account profile). For example, a first user may initiate a transfer of funds to a second user (such as the first user gifting $1.00 to the second user). The first user may identify a destination to provide the funds as a phone number associated with the second user. The phone number may have no corresponding digital wallet and is thus unregistered.

The request may include a payload comprising: sender account identifiers (such as bank-issued credentials or user ID), the sender's phone number, the recipient's phone number, transfer amount and currency, and/or the like. The asset transfer manager 306 may invoke the verification engine 308 to vet the recipient number's eligibility as described herein. In some embodiments, the sender may have the quantity of blockchain unit on-chain (such as on the blockchain 318) and the sender may provide the sender's signing key to send the quantity of blockchain unit (thus, a financial institution is not involved in this situation).

In some embodiments, the verification engine 308 obtains and evaluates telecommunication metadata and compliance signals to determine eligibility of the unregistered phone number to receive the quantity of blockchain unit. The verification engine 308 may issue API calls to one or more telecom providers to retrieve SIM-swap status and timestamp, SIM age, port-out history, network-or IP-level identifiers (where available), and spoofing-detection flags. The verification engine 308 applies policy thresholds such that, for example, a SIM-swap flag within a configurable lookback window yields deny or step-up, a SIM age below a minimum yields step-up, and otherwise allow with risk-based limits. The verification engine 308 ingests results from the authenticator 304 (e.g., OTP success/failure or a carrier-verification assertion) when present, and in parallel executes sanctions and on-chain analytics screening, including checks against sanctions/PEP lists and analysis of exposure to known illicit clusters, abnormal flow patterns, cluster associations, and provider risk scores. The verification engine 308 produces an eligibility indicator (allow/deny/step-up) with reason codes and persists the decision and raw evidence for audit. The wallet generation flow proceeds in response to the eligibility indicator is allow (or step-up is satisfied); otherwise, the request is rejected or deferred pending step-up authentication.

In some examples, before onboarding the unregistered phone number, the verification engine 308 may determine the unregistered phone number meets compliance, for example, compliance with relevant safeguards for cross-border fund transfers. For example, the verification engine 308 may initiate a cross-border identity verification sequence to validate that the phone number's country of origin, subscriber information, and associated identity credentials satisfy thresholds required under applicable financial regulations. Where a stablecoin transaction involves counterparties in different jurisdictions, the verification engine 308 may check the phone number against international sanctions and fraud databases, verify compliance with jurisdiction-specific obligations, and ensure that identity data required by jurisdiction standards is collected and securely transmitted. The verification engine 308 may also perform enhanced due-diligence procedures for phone numbers originating in high-risk jurisdictions, such as requiring secondary biometric or document verification, to prevent unauthorized use of telecom identifiers for cross-border stablecoin transfers. In response to completions of verification, the verification engine 308 may tag the phone number with a jurisdiction-specific compliance token, allowing validated numbers to initiate or receive stablecoin transactions across borders while maintaining audit trails for compliance purposes, such as AML and sanctions-screening.

In some embodiments, the wallet manager 310 may deterministically derive a blockchain address for the unregistered phone number without requiring prior user registration. The wallet manager 310 computes a per-number cryptographic salt using an OPRF, taking as input the unregistered phone number and bytecode to produce a cryptographic salt. The wallet manager 310 provides the cryptographic salt and the bytecode to a blockchain address generator and computes the blockchain address. The wallet manager 310 stores the computed address, cryptographic salt, bytecode, and/or the like in a datastore. In some cases, the address is precomputed and the quantity of blockchain unit may be sent to that address prior to activation. The wallet manager 310 may deploy an autonomous program protocol 152, such as a smart contract, at the computed blockchain address. The wallet manager 310 exposes the derived address to upstream orchestration for subsequent transfer and key binding, while preventing enumeration by keeping the PRF/OPRF key secret and binding salts to domain-separated contexts.

In some cases, in response to a wallet being created for the unregistered phone number, wallet manager 310 may may generate the blockchain address associated with the unregistered phone number. For example, generation of the wallet may include deploying an autonomous program protocol 152 to generate the wallet at the blockchain address via the virtual machine 154. In this way, the generation of the wallet may cause the wallet manager 310 to generate the blockchain address associated with the blockchain wallet. The autonomous program protocol 152 may set signing policy for the wallet that relies on MPC key shards. The blockchain address may correspond to a quantity of blockchain unit 153 on the blockchain 150 and may receive token transfers before deployment, with deployment executed by the virtual machine 154. The autonomous program protocol 152 may include authentication algorithm that allows holder of the cryptographic key material to access the autonomous program protocol 152.

In some embodiments, the key management engine 312 provisions cryptographic key material for the generated wallet and binds the cryptographic key material to the autonomous program protocol 152 recorded at the blockchain address. The cryptographic key material may be in different versions, depending on implementations in different embodiments. In some cases, the version of the cryptographic signing key includes one or more shards of the cryptographic signing key in a multi-party computation (MPC). For example, the cryptographic signing key may be divided into a plurality of key shards. The key management engine 312 generates or registers shards such as a device shard, an authentication shard, and a recovery shard (for example, a 2-of-3 Shamir's Secret Sharing scheme), associating each shard's commitment with the recipient's phone number, the wallet address, and/or the like. In some embodiments, the device shard is staged for delivery to the recipient device through a secure notification flow (for example, embedded in or retrievable via a URL delivered over a messaging channel) and stored device-locally upon access. In some examples, the key management engine 312 may release the authentication shard to the user device 302 upon successful number verification. In some cases, the key management engine 312 withholds the authentication shard even upon successful number verification (for example, the computing server 120 stores the authentication shard). For example, the user device 110 may obtain a shard (such as the device shard) and the key management engine 312 withholds another shard (such as the authentication shard). In this way, the user device 110 may use the computing server 120 to control the blockchain address but the computing server 120 may be unable to control the blockchain address. In other cases, the version of the cryptographic key material is the entirety of the signing key if no MPC is implemented.

In embodiments using MPC, the device shard may eventually be delivered to the user device 110. For example, the device shard may be stored in a secure enclave of the user device 110. In some cases, the user device 110 may receive a cookie which includes a pointer to the device shard on the user device 110. The user device 110 may obtain the cookie, for example, when accessing a web application associated with transferring the blockchain unit. In this way, in response to the user device 110 receiving a click on a link in the notification and open the web application, the cookie may include a pointer to the device shard and the user device 110 may obtain the device shard for reconstructing the signing key. In some cases, the user may not further invoke or use the device shard just by SMS. SMS is used only for notifications to provide a notification that a user has received funds. To access or send funds, the user may open the web application where the web application to trace the cookie to locate where the device shard resides and can be utilized to assemble cryptographic key material in a secure enclave associated with the browser.

Regarding the web application version, in response to the user opening the web application, the web application may check for the presence of the device shard. For example, in some cases, the web application may check for existence of a cookie in the browser's stored cookies. The cookie may include a pointer to the device shard, which may be stored in a secure enclave of the user device 110. In this way, the web application may identify where the device shard is and can use the device shard for secure signing of transactions. In some cases, if the cookie is lost (e.g., in clearing cookies or switching devices), the recovery process may rely on other shards (such as the authentication shard and/or the recovery shard) to regenerate a new device shard.

Regarding a mobile application, the key-shard retrieval process may be similar to the web application. For example, in response to the application is opened, the device shard may be created and stored locally on the user device 110. The mobile application may generate and securely store the device shard (for example, in a secure storage area specific to the user device 110 and app, such as the secure enclave on a operating system). The application may identify the device shard in response to the device shard having previously been stored on the user device 110. In some cases, the user device 110 may create a new device shard or, if restoring or recovering an account (such as after reinstalling or switching devices), initiate the recovery process using the other shards (for example, the authentication shard and/or recovery shard), authenticating the user and then regenerating the device shard for continued secure access.

In some embodiments, responsive to a transfer request and generating the recipient's blockchain address, a notification engine 314 generates and transmits a notification to the recipient phone number indicating that a quantity of blockchain unit has been sent and providing a secure access URL. The notification engine 314 selects one or more delivery channels (e.g., SMS, application programming interface, email, and/or the like), and constructs a signed payload embedded in the URL, such as a token comprising fields including recipient_number, destination_address, chain_id, token_contract, amount, currency, memo, expiration_timestamp (TTL), nonce, and an idempotency key; the payload may be signed with a server-held key. The message body is templated with human-readable content (for example, “you just received $X—open the link to view your balance”). Upon user interaction, the second user device 316 presents the token to the server over HTTPS; the server validates signature, TTL, nonce uniqueness, and idempotency. In some embodiments, the notification includes or triggers delivery of a device shard used in reconstructing a cryptographic signing key, and can be embedded in a third-party application via an iframe that sources the access URL to drive the same validation flow.

In some embodiments, the second user device 316 performs authentication with the authenticator 304 as described herein with respect to the first user device 302 (and/or as described with respect to the authenticator 210).

In some embodiments, after recipient authentication, the asset transfer manager 306 causes delivery of the quantity of blockchain unit to the recipient's blockchain address and records settlement to the blockchain 318. The second user device 316 assembles a reconstruction of the signing key using available key shards (for example, device shard and authentication shard) and returns a raw signed transaction. The transaction associated with the quantity of blockchain unit may be recorded on a blockchain (such as blockchain 150) for the precomputed address prior to activation.

In some embodiments, after obtaining and accessing the blockchain address, a recipient associated with the unregistered phone number may cause a subsequent transfer of another quantity of blockchain unit by using the computing server 120. For example, the recipient may authorize a transaction with the cryptographic key material used to access the blockchain address (such as the shards associated with the MPC and the key management engine 312). In some cases, the recipient's device (such as the second user device 316) may store (such as locally persisted in a secure enclave) the device shard created during access. In response to initiating a new transfer, the authenticator 304 may authorize release of the authentication shard to the recipient's device. In this way, the second user device 316 may access the shards to produce a signature for the transaction. The computing server 120 may orchestrate execution of the transfer of the other quantity of blockchain unit (for example, as described herein in FIG. 3 and FIG. 4).

In some cases, the computing server 120 may perform blockchain operations for the transfer of the quantity of blockchain for a seamless user experience. The blockchain operations may include address derivation, transaction construction, signing, and submission behind an authenticated application workflow, thereby eliminating direct user interaction with blockchain-specific parameters such as nonce, gas estimation, fee tokens, and RPC/node selection. For example, in response to a user's request to transfer the quantity of blockchain unit, the wallet manager 310 may compute the recipient's blockchain address for later deployment, while the asset transfer manager 306 may assemble the quantity of blockchain unit. In this way, the computing server 120 may delegate the blockchain operations, such as network selection, fee estimation/sponsorship, and broadcasting to the blockchain 318. In some cases, transaction authorization is based on applying the cryptographic key material and returning the resulting signature to the computing server 120 for submission. In this way, execution may be carried out by the virtual machine 154 and recorded on the blockchain 150 (and components thereof). In this way, abstracting the blockchain operations may remove the blockchain operations from end users so the user experience remains simple.

### Example Process

FIG. 4 is a flowchart depicting an example process 400 for sending blockchain units (e.g., cryptocurrency such as stable coins) to a user without custody by a centralized server, in accordance with some embodiments. While process 400 is primarily described as being performed by the computing server 120, in various embodiments the process 400 may also be performed by any suitable computing devices. In some embodiments, one or more steps in the process 400 may be added, deleted, or modified. In some embodiments, the steps in the process 400 may be carried out in a different order that is illustrated in FIG. 4.

In some embodiments, the computing server 120 may receive 410 a request to transfer a quantity of blockchain unit to an unregistered phone number. The request may include a payload that includes sender identity (such as name, phone number, and/or the like), the unregistered phone number, transfer amount, the type and/or quantity of blockchain unit, bank-issued credentials (such as customer account identifier), and/or the like. In some examples, the request may be sent by a first user device (such as user device 110) that is in a first country. In some examples, the computing server 120 may receive an application programming interface call through the application programming interface 250, for example, the call including the payload. The unregistered phone number may be any phone number that is a target for receiving funds. The funds may be in the form of transferring a quantity of blockchain unit to a wallet associated with the unregistered phone number. In some cases, the unregistered phone number may not have a digital wallet established to transfer the quantity of blockchain units associated with the transfer of funds (no device shard created, no on-chain wallet code deployed, and/or no existing account profile). For example, a first user may initiate a transfer of funds to a second user (such as the first user gifting $1.00 to the second user). The first user may identify a destination to provide the funds as a phone number associated with the second user. The phone number may have no corresponding digital wallet and is thus unregistered.

In some embodiments, the computing server 120 may perform vetting (e.g., compliance checks) of the unregistered phone number. In some cases, the vetting the unregistered phone may include the computing server 120 evaluating telecommunication metadata associated with the unregistered phone number (such as SIM-swap indicators and timestamps, SIM age, spoofing flags, port-out history, and, where available, network/IP-level identifiers). The computing server 120 may query a telecommunication server 140 for the telecommunication metadata. The computing server 120 may evaluate carrier-reported compromised numbers (for example, from the telecommunication server 140), recent SIM-swap watch events within a configurable lookback window, spoofing incidents, sanctioned phone numbers, and/or the like. In some cases, the computing server 120 may generate a determination about the unregistered phone number (such as an indicator noting allowance/denial of transfer of the quantity of blockchain unit).

In some embodiments, the computing server 120 may create 415 cryptographic custody of the quantity of blockchain unit for the unregistered phone number to access. Cryptographic custody may refer to the ability for an entity to prove ownership of or enable access to a digital asset on a blockchain (for example, the quantity of blockchain unit) in a cryptographically secured way, such as by using a cryptographic key material to generate digital signatures to prove the ownership associated with the digital asset or the ownership of a blockchain address that holds the digital asset. In some cases, the cryptographic custody may include placement of the quantity of blockchain unit on the blockchain 150 at a blockchain address that is associated with a recipient's phone number. In this way, the quantity of blockchain unit may be accessible by the recipient by proving ownership and the cryptographic key material to generate digital signature.

In some embodiments, as part of creating the cryptographic custody, the computing server 120 may deterministically calculate the blockchain address that is associated with the unregistered phone number. In some embodiments, the computing server 120 may determine the value of the blockchain address by generating the blockchain address from a cryptographic salt that is associated with the unregistered phone number and a bytecode. The computing server 120 may obtain the cryptographic salt (such as a 32-byte value) via a pseudorandom function (such as OPRF, a server-side pseudo random function (for example, HMAC-SHA256), and/or the like). The pseudorandom function may allow the cryptographic salt to preserve determinism for the unregistered phone number to access the blockchain address. In some cases, generating the cryptographic salt is based on a server (for example, a key management server not shown) having a secret key to generate the cryptographic salt so that the salt seems to be random but the cryptographic salt is deterministic by the server. In such embodiments, the salt may be deterministic from the server perspective but become untraceable to other parties so that other parties may not attack or tamper the value of the blockchain address based on the phone number. The computing server 120 may generate the bytecode for the blockchain address as a sequence of opcodes (ADD, SSTORE, CALL, etc.) to update a state of the blockchain 150 deterministically. In some cases, the computing server 120 may compute the blockchain address by inputting the cryptographic salt and the bytecode to a blockchain address generator (such as EVM CREATE2). In some cases, the computing server 120 may generate the blockchain address in response to receiving the request to transfer the quantity of blockchain unit. The computing server 120 may precompute the blockchain address before a corresponding wallet is deployed on the blockchain 150, for example, by using EVM CREATE2. As such, while the computing server 120 determines the value of the blockchain address, the blockchain address may not have in fact recorded on a blockchain 150 until another trigger event such as when the blockchain unit is actually transmitted to the blockchain address. In some embodiments, the determination of the value of the blockchain address and the recordation of the transfer of the blockchain unit to the blockchain address may occur almost simultaneously.

In some embodiments, cryptographic custody may be associated with the blockchain address and a cryptographic signing key corresponding to the blockchain address. In some embodiments, the cryptographic signing key may confer authority by a possessor to execute transactions associated with the blockchain address. In some cases, cryptographic key material may correspond to the signing key and may take different forms, such shards used for MPC implementation. The cryptographic key material may be material that is used to assemble to signing key, data that allows a device to retrieve the signing key or, in some cases, the signing key itself in implementations that do not use MPC. The shards may be based on Shamir's Secret Sharing, such that two of three shards may be used to reconstruct the cryptographic signing key for interacting with the blockchain address. The shards may include a device shard, an authentication shard, and a recovery shard. The device shard may be stored locally on a user device (such as a user device of the user devices 110) that uniquely identifies the user device is associated with the signing key (for example, stored in a secure enclave on the device), an authentication shard may be provided by an authentication service (such as the authenticator 210) to the device in response to successful phone-number verification, and a recovery shard that allows for recovery of the device shard from another device that is different from the device originally associated with the signing key (for example, in response to the user changing the unregistered phone number to a new phone).

The cryptographic key material that is used to generate digital signature may vary in different embodiments. For example, a version of the cryptographic key may include one or more of the shards. A version of the cryptographic key may correspond to a signer of an autonomous program protocol, such as a smart account wallet. In some embodiments, the signer may be a sole signer. In some cases, the cryptographic signing key may be a key stored on the device, a server-based key, obtained from a key management service, and/or the like). What version of the cryptograph key the computing server 120 creates may depend on the key management security that the computing server 120 may have implemented. For example, in MPC, the versions created may be key shards. In some cases, responsive reconstruction of the signing key, the user device 110 may not store the signing key in the secure enclave (or elsewhere on the user device 110). In some cases, however, the user device 110 may store the signing key (for example, the user device 110 may store the signing key in the secure enclave). In implementation without MPC, the cryptographic key material may be the entire signing key, instead of a shard.

In some embodiments, the computing server 120 may transmit 420 a notification to the unregistered phone number for access of the cryptographic custody. The notification may be a message sent to the device associated with the unregistered phone number to provide notice that the quantity of blockchain unit have been (or will be) transferred and provide a secure way to access the quantity of blockchain unit (for example, via a URL associated with the notification). In some embodiments, the computing server 120 (for example, via the notification engine 230) may cause transmission of the notification that includes the version of the cryptographic signing key (for example, the version including the device shard) to the device associated with the unregistered phone number. In some cases, the computing server 120 may cause transmission of the notification, such as via an SMS or another suitable notification channel. For example, the computing server 120 may send an application programming interface call to the telecommunication server 140 instructing to send the notification to the unregistered phone number. In some examples, accessing the cryptographic custody may be granting the device associated with the unregistered phone number cryptographic control over the quantity of blockchain unit at the blockchain address associated with the unregistered phone number. In some cases, the device that obtains cryptographic custody may be referred to herein as a blockchain custodian. In some cases, the computing server 120 may transmit the notification via a third-party application by using an embedded frame associated with the third-party application. The third-party application may render a secure, embedded frame (such as an HTML iframe) that hosts a user interface (for example, for accessing the blockchain address, blockchain units, and/or the like). In some cases, in response to interaction with the notification, the third-party application may execute an iframe element that routes a source to the URL and causes execution of the link of the URL.

In some embodiments, the computing server 120 may receive 425 a response notification that the device associated with the unregistered phone number has interacted with an aspect of the notification (such as a URL). For example, the computing server 120 (via application programming interface 250) may receive the response notification as a message (such as a token sent via HTTPS) that includes a payload having an indicator of intent to transfer the quantity of blockchain unit, the unregistered phone number, and/or the like. In response to receiving the response notification, the computing server 120 may validate the payload against information associated with the notification (for example, unregistered phone number, quantity of blockchain unit, blockchain address, and/or the like that may be stored in the data store 260).

In some embodiments, the computing server 120 may cause 430 transmission of cryptographic signing key material to the device to enable the device to have cryptographic control over the smart account wallet. The cryptographic key material may be data used by a signer (for example, the user's device or MPC network) to produce valid digital signatures for blockchain transactions or operations. In some examples, cryptographic control may correspond to the act of obtaining the version of the cryptographic signing key corresponding to the blockchain address (such as, obtaining the device shard and the authentication shard) to be able to control the wallet associated with the blockchain address. An entity that is in cryptographic control of the blockchain address may be referred to as having cryptographic custody for the blockchain address. The computing server 120 may cause transmission of the version of the corresponding cryptographic signing key according to the messaging methods described herein (for example, via URL interaction from an SMS message, via application programming interface calls, interaction with iframe embedding that causes execution of the URL, and/or the like).

In some embodiments, the computing server 120 may cause the device of the unregistered phone number to perform a reconstruction (or partial reconstruction) of the cryptographic signing key using the version of the cryptographic signing key. For example, the reconstruction based on the device shard and the authentication shard (without transmitting or assembling the full cryptographic signing key). The device may retrieve the device shard (for example, from a pointer provided by a cookie). In response to the device performing authentication (such as described with respect to the authenticator 210), the computing server 120 may provide the authentication shard to the device. In some cases, the device performs the reconstruction (or partial reconstruction) of the cryptographic private key by using Shamir's Secret Sharing to assemble the reconstruction of the cryptographic signing key to access the blockchain address associated with the unregistered phone number. In some embodiments, the computing server 120 may cause the device to request the version of the cryptographic signing key from an external key-service provider and access the blockchain address with the version provided by the key-service provider, without any centralized server ever assembling the full key. In some cases, in response to the device receiving the notification, the device may send a call to an external key application programming interface endpoint (such as POST/keys/auth-share), presenting at least the notification from the computing server 120, the unregistered phone number, and/or the like. The external key-service provider may validate the notification and unregistered phone number. The external key-service provider may provide the version of the cryptographic signing key to the device. The device may obtain the version of the cryptographic signing key to access the blockchain address. In some embodiments, the computing server 120 may cause the device to obtain the version of the cryptographic signing key from device-local storage, without receiving the version of the cryptographic signing key from another source, thereby enabling cryptographic control over the blockchain address.

In some embodiments, the computing server 120 may register the unregistered phone number as the blockchain custodian of the quantity of blockchain unit in response to the device performing the reconstruction (or partial reconstruction) of the version of the cryptographic signing key. In some cases, the computing server 120 may register the unregistered phone number as the blockchain custodian by creating a record (for example, on the computing server 120 via the data store 260) that the unregistered phone number has access to the quantity of blockchain units (such as a quantity of stablecoin). In some examples, the computing server 120 may register the unregistered phone number as the blockchain custodian by broadcasting a transaction request on the blockchain 150 to transfer the quantity of the blockchain units to the blockchain address.

### Example User Interface

FIG. 5 illustrates an example user interface that shows an SMS notification 505 from an application (for example, as executed by the computing server 120) informing a recipient that $1.00 has been received and providing a link 510 to open the application and view the balance. In this way, SMS messaging is used for notifications and to route the user into the application. In some cases, authorization and wallet actions are completed in response to the user interface receives interaction with the link 510. In some cases, in response to interaction with the link 510, the application can verify phone-number ownership (such as, via OTP or carrier-based checks). In some cases, the systems as described herein (such as the computing server 120) may provide the device shard for accessing a blockchain address according to the phone number. In response to authentication, the application may display the on-chain balance and enables further actions. While SMS is used as an example, other notification channels may also be used by a telecommunication server 140. In some examples, prior to the SMS notification shown in FIG. 5, a sender may interact with an application interface to enter a recipient phone number, transfer amount, and optional memo. Upon confirmation, the computing server 120 automatically resolves the recipient phone number to the correct settlement destination and performs conversion and broadcast operations as required by the selected transfer rail. In this way, the sender is not exposed to blockchain-specific parameters such as addresses or gas fees. In some cases, in response to the recipient receiving the notification shown in FIG. 5, the link directs the user to an interface that can display the received value in digital-asset or local-fiat form, depending on jurisdiction or banking linkage. If the phone number is associated with a financial institution, the system may trigger off-ramp settlement into the recipient's local bank account. Otherwise, the on-chain balance is shown and may be accessed through the non-custodial wallet interface. Together, these interfaces represent the complete end-to-end user experience—from entering the phone number and amount to final receipt of funds—without direct user interaction with the underlying blockchain or wallet configuration.

### Example Blockchain Architecture

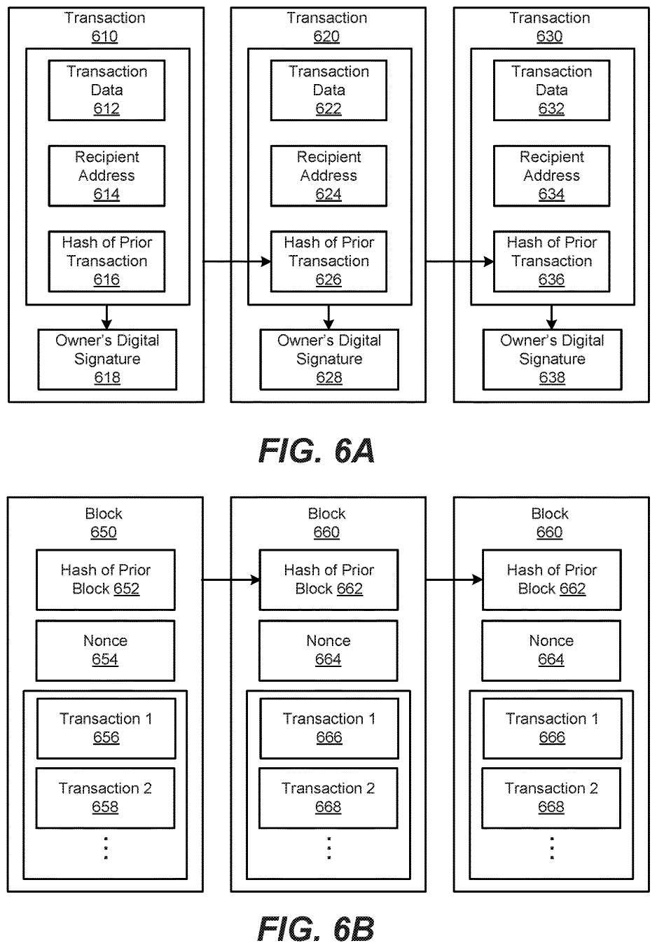

FIG. 6A is a block diagram illustrating a chain of transactions broadcasted and recorded on a blockchain, in accordance with some embodiments. The transactions described in FIG. 6A may correspond to any of the transactions and the transfer of blockchain-based units described in previous figures.

In some embodiment, a blockchain is a distributed system. A distributed blockchain network may include a plurality of nodes. Each node is a user or a server that participates in the blockchain network. In a public blockchain, any participant may become a node of the blockchain. The nodes collectively may be used as a distributed computing system that serves as a virtual machine of the blockchain. In some embodiments, the virtual machine or a distributed computing system may be simply referred to as a computer. Any users of a public blockchain may broadcast transactions for the nodes of the blockchain to record. Each user's digital wallet is associated with a private cryptographic key that is used to sign transactions and prove the ownership of a blockchain-based unit. The signing key may be stored in the memory of a user device 110 that is possessed by the user. In another case, the signing key may be stored in pieces in a distributed manner through techniques such as multi-party computation (MPC). In any case, regardless of the manner of storage of the signing key, it is considered that a user device 110 is in possession of the signing key.

The ownership of a blockchain-based unit may be traced through a chain of transactions. In FIG. 6A, a chain of transactions may include a first transaction 610, a second transaction 620, and a third transaction 630, etc. Each of the transactions in the chain may have a fairly similar structure except the very first transaction in the chain. The first transaction of the chain may be generated by a smart contract or a mining process and may be traced back to the smart contract that is recorded on the blockchain or the first block in which it was generated. While each transaction is linked to a prior transaction in FIG. 6A, the transaction does not need to be recorded on consecutive blocks on the blockchain. For example, the block recording the transaction 610 and the block recording the transaction 620 may be separated by hundreds or even thousands of blocks. The traceback of the prior block is tracked by the hash of the prior block that is recorded by the current block. In some embodiments, account model is used and transactions do not have any references to previous transactions. Transactions are not chained and do not contain the hash of the previous transaction.

Referring to one of the transactions in FIG. 6A, for illustration, the transaction 620 may be referred to as a current transaction. Transaction 610 may be referred to as a prior transaction and transaction 630 may be referred to as a subsequent transaction. Each transaction includes a transaction data 622, a recipient address 624, a hash of the prior transaction 626, and the current transaction's owner's digital signature 628. The transaction data 622 records the substance of the current transaction 620. For example, the transaction data 622 may specify a transfer of a quantity of a blockchain-based unit (e.g., a coin, a blockchain token, etc.). In some embodiments, the transaction data 622 may include code instructions of a smart contract.

The recipient address 624 is a version of the public key that corresponds to the signing key of the digital wallet of the recipient. In some embodiments, the recipient address 624 is the public key itself. In another embodiment, the recipient address 624 an encoded version of the public key through one or more functions such as some deterministic functions. For example, the generation of the recipient address 624 from the public key may include hashing the public key, adding a checksum, adding one or more prefixes or suffixes, encoding the resultant bits, and truncating the address. The recipient address 624 may be a unique identifier of the digital wallet of the recipient on the blockchain. The signing key may be a signing key held by a device, a signing key linked to a multi-signature wallet, a signing key held by MPC mechanism, or another suitable signing key.

The hash of the prior transaction 626 is the hash of the entire transaction data of the prior transaction 610. Likewise, the hash of the prior transaction 636 is the hash of the entire transaction data of the transaction 620. The hashing of the prior transaction 610 may be performed using a hashing algorithm such as a secure hash algorithm (SHA) or a message digest algorithm (MD). In some embodiments, the owner corresponding to the current transaction 620 may also use the public key of the owner to generate the hash. The hash of prior transaction 626 provides a traceback of the prior transaction 610 and also maintains the data integrity of the prior transaction 610.

In generating a current transaction 620, the digital wallet of the current owner of the blockchain-based unit uses its signing key to encrypt the combination of the transaction data 622, the recipient address 624, and the hash of prior transaction 626 to generate the owner's digital signature 628. To generate the current transaction 620, the current owner specifies a recipient by including the recipient address 624 in the digital signature 628 of the current transaction 620. The subsequent owner of the blockchain-based unit is fixed by the recipient address 624. In other words, the subsequent owner that generates the digital signature 638 in the subsequent transaction 630 is fixed by the recipient address 624 specified by the current transaction 620. To verify the validity of the current transaction 620, any nodes in the blockchain network may trace back to the prior transaction 610 (by tracing the hash of prior transaction 626) and locate the recipient address 614. The recipient address 614 corresponds to the public key of the digital signature 628. The nodes in the blockchain network may use the public key to verify the digital signature 628. Hence, a current owner who has the blockchain-based unit tied to the owner's blockchain address can prove the ownership of the blockchain-based unit. In this disclosure, it can be described as the blockchain-based unit being connected to a public cryptographic key of a party because the blockchain address is derived from the public key.

The transfer of ownership of a blockchain-based unit may be initiated by the current owner of the blockchain-based unit. To transfer the ownership, the owner may broadcast the transaction that includes the digital signature of the owner and a hash of the prior transaction. A valid transaction with a verifiable digital signature and a correct hash of the prior transaction will be recorded in a new block of the blockchain through the block generation process.

FIG. 6B is a block diagram illustrating a connection of multiple blocks in a blockchain, in accordance with some embodiments. Each block of a blockchain, except the very first block which may be referred to as the genesis block, may have a similar structure. The blocks 650, 660, and 660 may each include a hash of the prior blockchain 652, a nonce 654, and a plurality of transactions (e.g., a first transaction 656, a second transaction 658, etc.). Each transaction may have the structure shown in FIG. 6A.

In a block generation process, a new block may be generated through mining or voting. For a mining process of a blockchain, any nodes in the blockchain system may participate in the mining process. The generation of the hash of the prior block may be conducted through a trial and error process. The entire data of the prior block (or a version of the prior block such as a simplified version) may be hashed using the nonce as a part of the input. The blockchain may use a certain format in the hash of the prior block in order for the new block to be recognized by the nodes as valid. For example, in some embodiments, the hash of the prior block needs to start with a certain number of zeroes in the hash. Other criteria of the hash of the prior block may also be used, depending on the implementation of the blockchain.

In a voting process, the nodes in a blockchain system may vote to determine the content of a new block. Depending on the embodiment, a selected subset of nodes or all nodes in the blockchain system may participate in the votes. When there are multiple candidate new blocks that include different transactions are available, the nodes will vote for one of the blocks to be linked to the existing block. The voting may be based on the voting power of the nodes.

By way of example of a block generation process using mining, in generating the hash of prior block 662, a node may randomly combine a version of the prior block 650 with a random nonce to generate a hash. The generated hash is somewhat a random number due to the random nonce. The node compares the generated hash with the criteria of the blockchain system to check if the criteria are met (e.g., whether the generated hash starts with a certain number of zeroes in the hash). If the generated hash fails to meet the criteria, the node tries another random nonce to generate another hash. The process is repeated for different nodes in the blockchain network until one of the nodes finds a hash that satisfies the criteria. The nonce that is used to generate the satisfactory hash is the nonce 664. The node that first generates the hash of the prior block 662 may also select what transactions that are broadcasted to the blockchain network are to be included in the block 660. The node may check the validity of the transaction (e.g., whether the transaction can be traced back to a prior recorded transaction and whether the digital signature of the generator of the transaction is valid). The selection may also depend on the number of broadcasted transactions that are pending to be recorded and also the fees that may be specified in the transactions. For example, in some embodiments, each transaction may be associated with a fee (e.g., gas) for having the transaction recorded. After the transactions are selected and the data of the block 660 is fixed, the nodes in the blockchain network repeat the trial and error process to generate the hash of prior block 662 by trying different nonce. In embodiments that use voting to generate new blocks, a nonce may not be needed. A new block may be linked to the prior block by including the hash of the prior block.

New blocks may be continued to be generated through the block generation process. A transaction of a blockchain-based unit (e.g., an electronic coin, a blockchain token, etc.) is complete when the broadcasted transaction is recorded in a block. In some embodiments, the transaction is considered settled when the transaction is considered final. A transaction is considered final when there are multiple subsequent blocks generated and linked to the block that records the transaction.

In some embodiments, some of the transactions 656, 658, 666, 668, 666, 668, etc. may include one or more smart contracts. The code instructions of the smart contracts are recorded in the block and are often immutable. When conditions are met, the code instructions of the smart contract are triggered. The code instructions may cause a computer (e.g., a virtual machine of the blockchain) to carry out some actions such as generating a blockchain-based unit and broadcasting a transaction documenting the generation to the blockchain network for recordation.

### Computing Machine Architecture

FIG. 7 is a block diagram illustrating components of an example computing machine that is capable of reading instructions from a computer-readable medium and execute them in a processor (or controller). A computer described herein may include a single computing machine shown in FIG. 7, a virtual machine, a distributed computing system that includes multiples nodes of computing machines shown in FIG. 7, or any other suitable arrangement of computing devices.

By way of example, FIG. 7 shows a diagrammatic representation of a computing machine in the example form of a computer system 700 within which instructions 724 (e.g., software, program code, or machine code), which may be stored in a computer-readable medium for causing the machine to perform any one or more of the processes discussed herein may be executed. In some embodiments, the computing machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The structure of a computing machine described in FIG. 7 may correspond to any software, hardware, or combined components shown in FIGS. 1 and 2, including but not limited to, the user device 110, the computing server 120, asset management server 130, telecommunication server 140, a node of a blockchain network, and various engines, modules interfaces, terminals, and machines shown in FIG. 2. While FIG. 7 shows various hardware and software elements, each of the components described in FIGS. 1 and 2 may include additional or fewer elements.

By way of example, a computing machine may be a personal computer (PC), a tablet PC, a set-top box (STB), a personal digital assistant (PDA), a cellular telephone, a smartphone, a web appliance, a network router, an internet of things (IoT) device, a switch or bridge, or any machine capable of executing instructions 724 that specify actions to be taken by that machine. Further, while only a single machine is illustrated, the term “machine” shall also be taken to include any collection of machines that individually or jointly execute instructions 724 to perform any one or more of the methodologies discussed herein.

The example computer system 700 includes one or more processors (generally, processor 702) (e.g., a central processing unit (CPU), a graphics processing unit (GPU), a digital signal processor (DSP), one or more application-specific integrated circuits (ASICs), one or more radio-frequency integrated circuits (RFICs), or any combination of these), a main memory 704, and a static memory 706, which are configured to communicate with each other via a bus 708. The computer system 700 may further include graphics display unit 710 (e.g., a plasma display panel (PDP), a liquid crystal display (LCD), a projector, or a cathode ray tube (CRT)). The computer system 700 may also include alphanumeric input device 712 (e.g., a keyboard), a cursor control device 714 (e.g., a mouse, a trackball, a joystick, a motion sensor, or other pointing instrument), a storage unit 716, a signal generation device 718 (e.g., a speaker), and a network interface device 720, which also are configured to communicate via the bus 708.

The storage unit 716 includes a computer-readable medium 722 on which is stored instructions 724 embodying any one or more of the methodologies or functions described herein. The instructions 724 may also reside, completely or at least partially, within the main memory 704 or within the processor 702 (e.g., within a processor's cache memory) during execution thereof by the computer system 700, the main memory 704 and the processor 702 also constituting computer-readable media. The instructions 724 may be transmitted or received over a network 726 via the network interface device 720.

While computer-readable medium 722 is shown in an example embodiment to be a single medium, the term “computer-readable medium” should be taken to include a single medium or multiple media (e.g., a centralized or distributed database, or associated caches and servers) able to store instructions (e.g., instructions 724). The computer-readable medium may include any medium that is capable of storing instructions (e.g., instructions 724) for execution by the machine and that cause the machine to perform any one or more of the methodologies disclosed herein. The computer-readable medium may include, but not be limited to, data repositories in the form of solid-state memories, optical media, and magnetic media. The computer-readable medium does not include a transitory medium such as a signal or a carrier wave.

### Additional Configuration Considerations

Additional configuration considerations are described herein. For example, the additional aspect of prevention methods for mistaken transactions (e.g., verifying recipient names if known to partner banks). In some cases, due to on-chain transfers being irreversible, the computing server 120 may include a pre-send confirmation. For example, in response to resolving a target phone number through a partner bank, if the bank recognizes the phone number, the user interface may display the recipient's name (first name and the first letter of the last name) and may display a prompt that request the sender to confirm before the transaction is submitted.

In some embodiments, the computing server 120 implements account abstraction. An account may be a smart contract that specifies its own validation rules (e.g., signature scheme, nonce handling, spending limits) and actions are conveyed as user operation objects rather than raw EVM transactions. For example, in an ERC-4337 realization, a user operation includes sender, nonce, call data (e.g., an ERC-20 transfer), and gas/payment fields to generate an account for a user associated with the user operation.

Certain embodiments are described herein as including logic or a number of components, engines, modules, or mechanisms, for example, as illustrated in FIG. 2. Engines may constitute either software modules (e.g., computer-implemented methods, code embodied on a non-transitory computer-readable medium, and/or the like) or hardware modules. A hardware engine is a tangible unit capable of performing certain operations and may be configured or arranged in a certain manner. In example embodiments, one or more computer systems (e.g., a standalone, client or server computer system) or one or more hardware engines of a computer system (e.g., a processor or a group of processors) may be configured by software (e.g., an application or application portion) as a hardware engine that operates to perform certain operations as described herein.

In various embodiments, a hardware engine may be implemented mechanically or electronically. For example, a hardware engine may comprise dedicated circuitry or logic that is permanently configured (e.g., as a special-purpose processor, such as a field programmable gate array (FPGA) or an application-specific integrated circuit (ASIC)) to perform certain operations. A hardware engine may also comprise programmable logic or circuitry (e.g., as encompassed within a general-purpose processor or another programmable processor) that is temporarily configured by software to perform certain operations. It will be appreciated that the decision to implement a hardware engine mechanically, in dedicated and permanently configured circuitry, or in temporarily configured circuitry (e.g., configured by software) may be driven by cost and time considerations.

The various operations of example methods described herein may be performed, at least partially, by one or more processors, e.g., processor 702, that are temporarily configured (e.g., by software) or permanently configured to perform the relevant operations. Whether temporarily or permanently configured, such processors may constitute processor-implemented engines that operate to perform one or more operations or functions. The engines referred to herein may, in some example embodiments, comprise processor-implemented engines.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Upon reading this disclosure, those of skill in the art will appreciate still additional alternative structural and functional designs for a similar system or process through the disclosed principles herein. Thus, while particular embodiments and applications have been illustrated and described, it is to be understood that the disclosed embodiments are not limited to the precise construction and components disclosed herein. Various modifications, changes, and variations, which will be apparent to those skilled in the art, may be made in the arrangement, operation and details of the method and apparatus disclosed herein without departing from the spirit and scope defined in the appended claims.

What is claimed is:

1. A computer-implemented method, comprising:
receiving a request to transfer a quantity of blockchain unit to an unregistered phone number;
creating a cryptographic custody of the quantity of blockchain unit for the unregistered phone number to access, the cryptographic custody associated with a blockchain address that has a record of holding the quantity of the blockchain unit and with a cryptographic signing key corresponding to a signer of the blockchain address, wherein creating the cryptographic custody comprises:
deterministically calculating, based on the unregistered phone number, the blockchain address of an autonomous program protocol, and
creating cryptographic signing key material corresponding to the signer of a smart account wallet;
transmitting a notification to the unregistered phone number for access of the cryptographic custody, the notification comprising a URL;
receiving an indication that a device associated with the unregistered phone number has interacted with the URL; and
causing a transmission of the cryptographic signing key material to the device to enable the device to have cryptographic control over the autonomous program protocol to access the quantity of blockchain unit.

2. The computer-implemented method of claim 1, wherein determining the blockchain address based on the unregistered phone number is completed prior to the blockchain address is activated on a blockchain.

3. The computer-implemented method of claim 1, wherein determining the blockchain address based on the unregistered phone number comprises:
generating a cryptographic salt based on the unregistered phone number; and
precomputing, prior to the blockchain address being activated on a blockchain, the blockchain address by using a blockchain address generator.

4. The computer-implemented method of claim 3, wherein generating the cryptographic salt comprises:
applying a server secret key to a version of the unregistered phone number, the server secret key associated with a server; and
generating the cryptographic salt based on the server secret key applying to the version of the unregistered phone number so that the cryptographic salt is deterministic with respect to the server.

5. The computer-implemented method of claim 1, further comprising performing compliance check of the unregistered phone number prior to creating the cryptographic custody.

6. The computer-implemented method of claim 5, wherein the compliance check comprises performing one or more of a SIM-swap detection, a SIM age check, or a carrier auth.

7. The computer-implemented method of claim 1, wherein the cryptographic signing key material includes a shard of the cryptographic signing key in a multi-party computation.

8. The computer-implemented method of claim 1, further comprising registering the unregistered phone number as a blockchain custodian of the quantity of blockchain unit.

9. The computer-implemented method of claim 1, further comprising determining whether phone number is linked to an asset management server and selecting settlement path from: (a) external off-ramp, (b) an omnibus crypto account, or (c) an embedded non-custodial wallet.

10. The computer-implemented method of claim 1, wherein the blockchain unit is a stablecoin.

11. The computer-implemented method of claim 1, wherein the request to transfer the quantity of blockchain unit is from a first user from a first country and the unregistered phone number is associated with a second user from a second country so that a transfer is a cross-border transfer.

12. The computer-implemented method of claim 1, wherein accessing to the blockchain address includes accessing a bank-embedded wallet.

13. A system, comprising:
one or more processors; and
memory storing code comprising instructions, wherein the instructions, when executed by the one or more processors, cause the one or more processors to:
receive a request to transfer a quantity of blockchain unit to an unregistered phone number;
create a cryptographic custody of the quantity of blockchain unit for the unregistered phone number to access, the cryptographic custody associated with a blockchain address that has a record of holding the quantity of the blockchain unit and with a cryptographic signing key corresponding to the blockchain address, wherein creating the cryptographic custody comprises:
deterministically calculating, based on the unregistered phone number, the blockchain address of an autonomous program protocol, and
creating cryptographic signing key material corresponding to a signer of a smart account wallet;
transmit a notification to the unregistered phone number for access of the cryptographic custody, the notification comprising a URL;
receive an indication that a device associated with the unregistered phone number has interacted with the URL; and
cause a transmission of the cryptographic signing key material to the device to enable the device to have cryptographic control over the autonomous program protocol to access the quantity of blockchain unit.

14. The system of claim 13, wherein determining the blockchain address based on the unregistered phone number is completed prior to the blockchain address is activated on a blockchain.

15. The system of claim 13, wherein the instructions to determine the blockchain address based on the unregistered phone number comprise instructions to:
generate a cryptographic salt based on the unregistered phone number; and
precompute, prior to the blockchain address being activated on a blockchain, the blockchain address by using a blockchain address generator.

16. The system of claim 15, wherein the instructions to generate the cryptographic salt comprises instructions to:
apply a server secret key to a version of the unregistered phone number, the server secret key belonging to a server; and
generate the cryptographic salt based on the server secret key applying to the version of the unregistered phone number so that the cryptographic salt is deterministic with respect to the server.

17. The system of claim 13, further comprising performing compliance check of the unregistered phone number prior to creating the cryptographic custody.

18. The system of claim 13, wherein the cryptographic signing key material includes a shard of the cryptographic signing key in a multi-party computation.

19. The system of claim 13, wherein the instructions, when executed by the one or more processors, further cause the one or more processors to register the unregistered phone number as a blockchain custodian of the quantity of blockchain unit.

20. A non-transitory computer-readable medium storing computer code comprising instructions, wherein the instructions, when executed by one or more processors, cause the one or more processors to:
receive a request to transfer a quantity of blockchain unit to an unregistered phone number;
create a cryptographic custody of the quantity of blockchain unit for the unregistered phone number to access, the cryptographic custody associated with a blockchain address that has a record of holding the quantity of the blockchain unit and with a cryptographic signing key corresponding to a signer of the blockchain address, wherein creating the cryptographic custody comprises:
deterministically calculating, based on the unregistered phone number, the blockchain address of an autonomous program protocol, and
creating cryptographic signing key material corresponding to the signer of a smart account wallet;
transmit a notification to the unregistered phone number for access of the cryptographic custody, the notification comprising a URL;
receive an indication that a device associated with the unregistered phone number has interacted with the URL; and
cause a transmission of the cryptographic signing key material to the device to enable the device to have cryptographic control over the autonomous program protocol to access the quantity of blockchain unit.
